(19) United States
(12) Patent Application Publication
(10) Pub. No.: US 2015/0294584 A1
(43) Pub. Date: Oct. 15, 2015

(54) NEUROPERFORMANCE

(71) Applicant: ASPEN PERFORMANCE TECHNOLOGIES, Tel Aviv (IL)

(72) Inventors: Jose Roberto KULLOK, Efrat (IL); Saul KULLOK, Efrat (IL)

(21) Appl. No.: 14/468,930

(22) Filed: Aug. 26, 2014

Related U.S. Application Data
(63) Continuation-in-part of application No. 14/251,116, filed on Apr. 11, 2014.
Application No. 14/251,116 is a continuation-in-part of application No. 14/251,163, filed on Apr. 11, 2014.
Application No. 14/251,163 is a continuation-in-part of application No. 14/251,007, filed on Apr. 11, 2014.
Application No. 14/251,007 is a continuation-in-part of application No. 14/251,034, filed on Apr. 11, 2014.
Application No. 14/251,034 is a continuation-in-part of application No. 14/251,041, filed on Apr. 11, 2014.

(51) Int. Cl. G09B 19/00; G09B 5/02

(52) U.S. Cl. CPC G09B 19/00; G09B 5/02

(57) ABSTRACT

Methods of promoting fluid intelligence abilities in a subject including the steps of: selecting one or more serial orders of open-bigram terms from a predefined library of open-bigram sequences, providing the subject with further selected one or more incomplete serial orders of open-bigram terms; prompting the subject to reason in order to sensory motor manipulate open-bigram terms or to reason in order to sensorially discriminate differences or sameness between two or more of incomplete open-bigram sequences; determining whether the subject correctly sensory motor manipulated the open-bigram terms or sensorially discriminated differences or sameness; and displaying the correct sensory motor manipulations or sensorially discriminated differences or sameness with at least one different spatial or time perceptual related attribute to highlight the correct answer.

This is a Continuation-In-Part of U.S. patent application Ser. No. 14/251,116, U.S. patent application Ser. No. 14/251,163, U.S. patent application Ser. No. 14/251,007, U.S. patent application Ser. No. 14/251,034, and U.S. patent application Ser. No. 14/251,041, all filed on Apr. 11, 2014, the disclosure of each which is hereby incorporated by reference.

### FIELD

The present disclosure relates to a system, method, software, and tools employing a novel disruptive non-pharmacological technology that prompts correlation of a subject's sensory-motor-perceptual-cognitive activities with novel constrained sequential statistical and combinatorial properties of alphanumerical series of symbols (e.g., in alphabetical series, letter sequences and series of numbers). These statistical and combinatorial properties determine alphanumeric sequential relationships by establishing novel interrelations, correlations and cross-correlations among the sequence terms. The new interrelations, correlations and cross-correlations among the sequence terms prompted by this novel non-pharmacological technology sustain and promote neural plasticity in general and neural-linguistic plasticity in particular. This technology is carried out through new strategies implemented by exercises particularly designed to amplify these novel sequential alphanumeric interrelations, correlations and cross-correlations. More importantly, this non-pharmacological technology entwines and grounds sensory-motor-perceptual-cognitive activity to statistical and combinatorial information constraining serial orders of alphanumeric symbols sequences. As a result, the problem solving of the disclosed body of alphanumeric series exercises is hardly cognitively taxing and is mainly conducted via fluid intelligence abilities (e.g., inductive-deductive reasoning, novel problem solving, and spatial orienting).

A primary goal of the non-pharmacological technology disclosed herein is maintaining stable cognitive abilities, delaying, and/or preventing cognitive decline in a subject experiencing normal aging. Likewise, this goal includes restraining working and episodic memory and cognitive impairments in a subject experiencing mild cognitive decline associated, e.g., with mild cognitive impairment (MCI) or pre-dementia and delaying the progression of severe working, episodic and prospective memory and cognitive decay at the early phase of neural degeneration in a subject diagnosed with a neurodegenerative condition (e.g., Dementia, Alzheimer's, Parkinson's). The non-pharmacological technology is beneficial as a training cognitive intervention designated to improve the instrumental performance of an elderly person in daily demanding functioning tasks by enabling some transfer from fluid cognitive trained abilities to everyday functioning. Further, this non-pharmacological technology is also beneficial as a brain fitness training/cognitive learning enhancer tool for the normal aging population, a subpopulation of Alzheimer's patients (e.g., stage 1 and beyond), and in subjects who do not yet experience cognitive decline.

### BACKGROUND

Brain/neural plasticity refers to the brain's ability to change in response to experience, learning and thought. As the brain receives specific sensorial input, it physically changes its structure (e.g., learning). These structural changes take place through new emergent interconnectivity growth connections among neurons, forming more complex neural networks. These recently formed neural networks become selectively sensitive to new behaviors. However, if the capacity for the formation of new neural connections within the brain is limited for any reason, demands for new implicit and explicit learning, (e.g., sequential learning, associative learning) supported particularly on cognitive executive functions such as fluid intelligence-inductive reasoning, attention, memory and speed of information processing (e.g., visual-auditory perceptual discrimination of alphanumeric patterns or pattern irregularities) cannot be satisfactorily fulfilled. This insufficient “neural connectivity” causes the existing neural pathways to be overworked and over stressed, often resulting in gridlock, a momentary information processing slow down and/or suspension, cognitive overflow or in the inability to dispose of irrelevant information. Accordingly, new learning becomes cumbersome and delayed, manipulation of relevant information in working memory compromised, concentration overtaxed and attention span limited.

Worldwide, millions of people, irrespective of gender or age, experience daily awareness of the frustrating inability of their own neural networks to interconnect, self-reorganize, retrieve and/or acquire new knowledge and skills through learning. In normal aging population, these maladaptive learning behaviors manifest themselves in a wide spectrum of cognitive functional and Central Nervous System (CNS) structural maladies, such as: (a) working and short-term memory shortcomings (including, e.g., executive functions), over increasing slowness in processing relevant information, limited memory storage capacity (items chunking difficulty), retrieval delays from long term memory and lack of attentional span and motor inhibitory control (e.g., impulsivity); (b) noticeable progressive worsening of working, episodic and prospective memory, visual-spatial and inductive reasoning (but also deductive reasoning) and (c) poor sequential organization, prioritization and understanding of meta-cognitive information and goals in mild cognitively impaired (MCI) population (who don't yet comply with dementia criteria); and (d) signs of neural degeneration in pre-dementia MCI population transitioning to dementia (e.g., these individuals comply with the diagnosis criteria for Alzheimer's and other types of Dementia.).

The market for memory and cognitive ability improvements, focusing squarely on aging baby boomers, amounts to approximately 76 million people in the US, tens of millions of whom either are or will be turning 60 in the next decade. According to research conducted by the Natural Marketing Institute (NMI), U.S., memory capacity decline and cognitive ability loss is the biggest fear of the aging baby boomer population. The NMI research conducted on the US general population showed that 44 percent of the US adult population reported memory capacity decline and cognitive ability loss as their biggest fear. More than half of the females (52 percent) reported memory capacity and cognitive ability loss as their biggest fear about aging, in comparison to 36 percent of the males.

Neurodegenerative diseases such as dementia, and specifically Alzheimer's disease, may be among the most costly diseases for society in Europe and the United States. These costs will probably increase as aging becomes an important social problem. Numbers vary between studies, but dementia worldwide costs have been estimated around $160 billion, while costs of Alzheimer in the United States alone may be $100 billion each year.

Currently available methodologies for addressing cognitive decline predominantly employ pharmacological interventions directed primarily to pathological changes in the brain (e.g., accumulation of amyloid protein deposits). However, these pharmacological interventions are not completely effective. Moreover, importantly, the vast majority of pharmacological agents do not specifically address cognitive aspects of the condition. Further, several pharmacological agents are associated with undesirable side effects, with many agents that in fact worsen cognitive ability rather than improve it. Additionally, there are some therapeutic strategies which cater to improvement of motor functions in subjects with neurodegenerative conditions, but such strategies too do not specifically address the cognitive decline aspect of the condition.

Thus, in view of the paucity in the field vis-à-vis effective preventative (prophylactic) and/or therapeutic approaches, particularly those that specifically and effectively address cognitive aspects of conditions associated with cognitive decline, there is a critical need in the art for non-pharmacological (alternative) approaches.

With respect to alternative approaches, notably, commercial activity in the brain health digital space views the brain as a “muscle”. Accordingly, commercial vendors in this space offer diverse platforms of online brain fitness games aimed to exercise the brain as if it were a “muscle,” and expect improvement in performance of a specific cognitive skill/domain in direct proportion to the invested practice time. However, vis-à-vis such approaches, it is noteworthy that language is treated as merely yet another cognitive skill component in their fitness program. Moreover, with these approaches, the question of cognitive skill transferability remains open and highly controversial.

The non-pharmacological technology disclosed herein is implemented through novel neuro-linguistic cognitive strategies, which stimulate sensory-motor-perceptual abilities in correlation with the alphanumeric information encoded in the sequential, combinatorial and statistical properties of the serial orders of its symbols (e.g., in the letters series of a language alphabet and in a series of numbers 1 to 9). As such, this novel non-pharmacological technology is a kind of biological intervention tool which safely and effectively triggers neuronal plasticity in general, across multiple and distant cortical areas in the brain. In particular, it triggers hemispheric related neural-linguistic plasticity, thus preventing or decelerating the chemical break-down initiation of the biological neural machine as it grows old.

The present non-pharmacological technology accomplishes this by principally focusing on the root base component of language, its alphabet, organizing its constituent parts, namely its letters and letter sequences (chunks) in novel ways to create rich and increasingly new complex non-semantic (serial non-word chunks) networking. This technology explicitly reveals the most basic minimal semantic textual structures in a given language (e.g., English) and creates a novel alphanumeric platform by which these minimal semantic textual structures can be exercised within the given language alphabet. The present non-pharmacological technology also accomplishes this by focusing on the natural numbers numerical series, organizing its constituent parts, namely its single number digits and number sets (numerical chunks) in novel serial ways to create rich and increasingly new number serial configurations.

From a developmental standpoint, language acquisition is considered to be a sensitive period in neuronal plasticity that precedes the development of top-down brain executive functions, (e.g., memory) and facilitates “learning”. Based on this key temporal relationship between language acquisition and complex cognitive development, the non-pharmacological technology disclosed herein places ‘native language acquisition’ as a central causal effector of cognitive, affective and psychomotor development. Further, the present non-pharmacological technology derives its effectiveness, in large part, by strengthening, and recreating fluid intelligence abilities such as inductive reasoning performance/processes, which are highly engaged during early stages of cognitive development (which stages coincide with the period of early language acquisition). Furthermore, the present non-pharmacological technology also derives its effectiveness by promoting efficient processing speed of phonological and visual pattern information among alphabetical serial structures (e.g., letters and letter patterns and their statistical and combinatorial properties, including non-word letter patterns), thereby promoting neuronal plasticity in general across several distant brain regions and hemispheric related language neural plasticity in particular.

The advantage of the non-pharmacological cognitive intervention technology disclosed herein is that it is effective, safe, and user-friendly, demands low arousal thus low attentional effort, is non-invasive, has no side effects, is non-addictive, scalable, and addresses large target markets where currently either no solution is available or where the solutions are partial at best.

### BRIEF DESCRIPTION OF DRAWINGS

FIG. 1 is a flow chart setting forth the broad concepts covered by the specific non-limiting exercises put forth in the Examples disclosed herein.

FIG. 2 is a flow chart setting forth the method that the exercises disclosed in Example 1 use in promoting inductive reasoning ability in a subject by inductively inferring the next open-bigram term in a direct alphabetical open-bigram sequence.

FIGS. 3A-3D depict a number of non-limiting examples of the exercises for inductively inferring the next open bigram term in an incomplete serial order of open-bigram terms. FIG. 3A shows a direct alphabetical serial order of open-bigram terms comprising three open-bigram terms and prompts the subject to correctly sensory motor select the fourth open bigram term. FIG. 3B shows that the correct sensory motor selection is the open-bigram term GH. Likewise, FIG. 3C shows an inverse alphabetical serial order of open-bigram terms comprising three open-bigram terms and prompts the subject to correctly sensory motor select the fourth open-bigram term. FIG. 3D shows that the correct sensory motor selection is the open-bigram term BA.

FIG. 4 is a flow chart setting forth the method that the present exercises use in promoting fluid intelligence abilities in a subject by reasoning about the similarity or disparity in open-bigram sequences.

FIGS. 5A-5B depict a non-limiting example of the exercises for reasoning about the sameness and differentness in two serial orders of open-bigram terms. FIG. 5A shows two serial orders of three (3) open-bigram terms and prompts the subject to sensory motor select whether the two serial orders of open-bigram terms are the same or different. FIG. 5B shows that the correct sensory motor selection is different.

### DETAILED DESCRIPTION

### Introduction

It is generally assumed that individual letters and the mechanism responsible for coding the positions of these letters in a string are the key elements for orthographic processing and determining the nature of the orthographic code. To expand the understanding of the mechanisms that interact, inhibit and modulate orthographic processing, there should also be an acknowledgement of the ubiquitous influence of phonology in reading comprehension. There is a growing consensus that reading involves multiple processing routes, namely the lexical and sub-lexical routes. In the lexical route, a string directly accesses lexical representations. When a visual image first arrives at a subject's cortex, it is in the form of a retinotopic encoding. If the visual stimulus is a letter string, an encoding of the constituent letter identities and positions takes place to provide a suitable representation for lexical access. In the sub-lexical route, a string is transformed into a phonological representation, which then contacts lexical representations.

Indeed, there is growing consensus that orthographic processing must connect with phonological processing quite early on during the process of visual word recognition, and that phonological representations constrain orthographic processing (Frost, R. (1998) Toward a strong phonological theory of visual word recognition: True issues and false trails, Psychological Bulletin, 123, 71_{—}99; Van Orden, G. C. (1987) A ROWS is a ROSE: Spelling, sound, and reading, Memory and Cognition, 15(3), 181-1987; and Ziegler, J. C., & Jacobs, A. M. (1995), Phonological information provides early sources of constraint in the processing of letter strings, Journal of Memory and Language, 34, 567-593).

Another major step forward in orthographic processing research concerning visual word recognition has taken into consideration the anatomical constraints of the brain to its function. Hunter and Brysbaert describe this anatomical constraint in terms of interhemispheric transfer cost (Hunter, Z. R., & Brysbaert, M. (2008), Theoretical analysis of interhemispheric transfer costs in visual word recognition, Language and Cognitive Processes, 23, 165-182). The assumption is that information falling to the right and left of fixation, even within the fovea, is sent to area V1 in the contralateral hemisphere. This implies that information to the left of fixation (LVF), which is processed initially by the right hemisphere of the brain, must be redirected to the left hemisphere (collosal transfer) in order for word recognition to proceed intact.

Still, another general constraint to orthographic processing is the fact that written words are perceived as visual objects before attaining the status of linguistic objects. Research has revealed that there seems to be a pre-emption of visual object processing mechanisms during the process of learning to read (McCandliss, B., Cohen, L., & Dehaene, S. (2003), The visual word form area: Expertise for reading in the fusiform gyrus, Trends in Cognitive Sciences, 13, 293-299). For example, the alphabetic array proposed by Grainger and van Heuven is one such mechanism, described as a specialized system developed specifically for the processing of strings of alphanumeric stimuli (but not for symbols) (Grainger, J., & van Heuven, W. (2003), Modeling letter position coding in printed word perception, In P. Bonin (Ed.), The mental lexicon (pp. 1-23), New York: Nova Science).

### Transposed Letter (TL) Priming

The effects of letter order on visual word recognition have a long research history. Early on during word recognition, letter positions are not accurately coded. Evidence of this comes from transposed-letter (TL) priming effects, in which letter strings generated by transposing two adjacent letters (e.g., “jugde” instead of “judge”) produce large priming effects, more than the priming effect with the letters replaced by different letters in the corresponding position (e.g., “junpe” instead of “judge”). Yet, the clearest evidence for TL priming effects was obtained from experiments using non-word anagrams formed by transposing two letters in a real word (e.g., “mohter” instead of “mother”) and comparing performance with matched non-anagram non-words (Andrews, S. (1996), Lexical retrieval and selection processes: Effects of transposed letter confusability, Journal of Memory and Language, 35, 775-800; Bruner, J. S., & O'Dowd, D. (1958), A note on the informativeness of parts of words, Language and Speech, 1, 98-101; Chambers, S. M. (1979), Letter and order information in lexical access, Journal of Verbal Learning and Behavior, 18, 225-241; O'Connor, R. E., & Forster, K. I. (1981), Criterion bias and search sequence bias in word recognition, Memory and Cognition, 9, 78-92; and Perea, M., Rosa, E., & Gomez, C. (2005), The frequency effect for pseudowords in the lexical decision task, Perception and Psychophysics, 67, 301-314). These experiments show that TL non-word anagrams are more often misperceived as a real word or misclassified as a real word in a lexical decision task than the non-anagram controls.

Other experiments that focused on the role of letter order in the perceptual matching task in which subjects had to classify two strings of letters as being either the same or different exhibited a diversity of responses depending on the number of shared letters and the degree to which the shared letters match in ordinal position (Krueger, L. E. (1978), A theory of perceptual matching, Psychological Review, 85, 278-304; Proctor, R. W., & Healy, A. F. (1985), Order-relevant and order-irrelevant decision rules in multiletter matching, Journal of Experimental Psychology: Learning, Memory, and Cognition, 11, 519-537; and Ratcliff, R. (1981), A theory of order relations in perceptual matching, Psychological Review, 88, 552-572). Observed priming effects were ruled by the number of letters shared across prime and target and the degree of positional match. Still, Schoonbaert and Grainger found that the size of TL-priming effects might depend on word length, with larger priming effects for 7-letter words as compared with 5-letter words (Schoonbaert, S., & Grainger, J. (2004), Letter position coding in printed word perception: Effects of repeated and transposed letters, Language and Cognitive Processes, 19, 333-367). More so, Guerrera and Foster found robust TL-priming effects in 8-letter words with rather extreme TL operations involving three transpositions e.g., 13254768-12345678 (Guerrera, C., & Forster, K. I. (2008), Masked form priming with extreme transposition, Language and Cognitive Processes, 23, 117-142). In short, target word length and/or target neighborhood density strongly determines the size of TL-priming effects.

Of equal importance, TL priming effects can also be obtained with the transposition of non-adjacent letters. The robust effects of non-adjacent TL primes were reported by Perea and Lupker with 6-10 letter long Spanish words (Perea, M., & Lupker, S. J. (2004), Can CANISO activate CASINO? Transposed-letter similarity effects with nonadjacent letter positions, Journal of Memory and Language, 51(2), 231-246). Same TL primes effects were reported in English words by Lupker, Perea, and Davis (Lupker, S. J., Perea, M., & Davis, C. J. (2008), Transposed-letter effects: Consonants, vowels, and letter frequency, Language and Cognitive Processes, 23, (1), 93-116). Additionally, Guerrera and Foster have shown that priming effects can be obtained when primes include multiple adjacent transpositions e.g., 12436587-12345678 (Guerrera, C., & Forster, K. I. (2008), Masked form priming with extreme transposition, Language and Cognitive Processes, 23, 117-142).

Past research regarding a possible influence of letter position (inner versus outer letters) in TL priming has shown that non-words formed by transposing two inner letters are harder to respond to in a lexical decision task than non-words formed by transposing the two first or the two last letters (Chambers, S. M. (1979), Letter and order information in lexical access, Journal of Verbal Learning and Behavior, 18, 225-241). Still, Schoonbaert and Grainger provided evidence that TL primes involving an outer letter (the first or the last letter of a word) are less effective than TL primes involving two inner letters (Schoonbaert, S., & Grainger, J. (2004), Letter position coding in printed word perception: Effects of repeated and transposed letters, Language and Cognitive Processes, 19, 333-367). Guerrera and Foster also suggested a special role of a word's outer letters (Guerrera, C., & Forster, K. I. (2008), Masked form priming with extreme transposition, Language and Cognitive Processes, 23, 117-142; and Jordan, T. R., Thomas, S. M., Patching, G. R., & Scott-Brown, K. C. (2003), Assessing the importance of letter pairs in initial, exterior, and interior positions in reading, Journal of Experimental Psychology: Learning, Memory, and Cognition, 29, 883-893).

In all of the above-mentioned studies, the TL priming contained all of the target's letters. When primes do not contain the entire target's letters, TL priming effects diminish substantially and tend to vanish (Humphreys, G. W., Evett, L. J., & Quinlan, P. T. (1990), Orthographic processing in visual word identification, Cognitive Psychology, 22, 517-560; and Peressotti, F., & Grainger, J. (1999), The role of letter identity and letter position in orthographic priming, Perception and Psychophysics, 61, 691-706).

### Relative-Position (RP) Priming

Relative-position (RP) priming involves a change in length across the prime and target such that shared letters can have the same order without being matched in terms of absolute length-dependent positions. RP priming can be achieved by removing some of the target's letters to form the prime stimulus (subset priming) or by adding letters to the target (superset priming). Primes and targets differing in length are obtained so that absolute position information changes while the relative order of letters is preserved. For example, for a 5-letter target e.g., 12345, a 5-letter substitution prime such as 12d45 contains letters that have the same absolute position in the prime and the target, while a 4-letter subset prime such as 1245 contains letters that preserve their relative order in the prime and the target but not their precise length-dependent position. Humphreys et al. reported significant priming for primes sharing four out of five of the target's letters in the same relative position (1245) compared to both a TL prime condition (1435) and an outer-letter only condition 1dd5 (Humphreys, G. W., Evett, L. J., & Quinlan, P. T. (1990), Orthographic processing in visual word identification, Cognitive Psychology, 22, 517-560).

Peressotti and Grainger provided further evidence for the effects of RL priming using the Foster and Davis masked priming technique. They reported that, with 6-letter target words, RP primes (1346) produced a significant priming effect compared with unrelated primes (dddd). Meanwhile, violation of the relative position of letters across the prime and the target e.g., 1436, 6341 cancelled priming effects relative to all different letter primes e.g., dddd (Peressotti, F., & Grainger, J. (1999), The role of letter identity and letter position in orthographic priming, Perception and Psychophysics, 61, 691-706). Grainger et al., reported small advantages for beginning-letter primes e.g., 1234/12345 compared with end-letter primes e.g., 4567/6789 (Grainger, J., Granier, J. P., Farioli, F., Van Assche, E., & van Heuven, W. (2006a), Letter position information and printed word perception: The relative-position priming constraint, Journal of Experimental Psychology: Human Perception and Performance, 32, 865-884). Likewise, an advantage for completely contiguous primes e.g., 1234/12345-34567/56789 is explained in terms of a phonological overlap in the contiguous condition compared with non-contiguous primes e.g., 1357/13457/1469/14569 (Frankish, C., & Turner, E. (2007), SIHGT and SUNOD: The role of orthography and phonology in the perception of transposed letter anagrams, Journal of Memory and Language, 56, 189-211). Further, Schoonbaert and Grainger utilize 7-letter target words containing a non-adjacent repeated letter such as “balance” and form prime stimuli “balnce” or “balace”. They reported priming effects were not influenced by the presence or absence of a letter repetition in the formed prime stimulus. On the other hand, performance to target stimuli independently of prime condition was adversely affected by the presence of a repeated letter, and this was true for both the word and non-word targets (Schoonbaert, S., & Grainger, J. (2004), Letter position coding in printed word perception: Effects of repeated and transposed letters, Language and Cognitive Processes, 19, 333-367).

### Letter Position Serial Encoding: The SERIOL Model

The SERIOL model (Sequential Encoding Regulated by Inputs to Oscillations within Letter units) is a theoretical framework that provides a comprehensive account of string processing in the proficient reader. It offers a computational theory of how a retinotopic representation is converted into an abstract representation of letter order. The model mainly focuses on bottom-up processing, but this is not meant to rule out top-down interactions.

The SERIOL model is comprised of five layers: 1) edges, 2) features, 3) letters, 4) open-bigrams, and 5) words. Each layer is comprised of processing units called nodes, which represent groups of neurons. The first two layers are retinotopic, while the latter three layers are abstract. For the retinotopic layers, the activation level denotes the total amount of neural activity across all nodes devoted to representing a letter within a given layer. A letter's activation level increases with the number of neurons representing that letter and their firing rate. For the abstract layers, the activation denotes the activity level of a representational letter unit in a given layer. In essence, the SERIOL model is the only one that specifies an abstract representation of individual letters. Such a letter unit can represent that letter in any retinal location, wherein timing firing binds positional information in the string to letter identity.

The edge layer models early visual cortical areas V1/V2. The edge layer is retinotopically organized and is split along the vertical meridian corresponding to the two cerebral hemispheres. In these early visual cortical areas, the rate of spatial sampling (acuity) is known to sharply decrease with increasing eccentricity. This is modelled by the assumption that activation level decreases as distance from fixation increases. This pattern is termed the ‘acuity gradient’. In short, the activation pattern at the lowest level of the model, the edge layer, corresponds to visual acuity.

The feature layer models V4. The feature layer is also retinotopically organized and split across the hemispheres. Based on learned hemisphere-specific processing, the acuity gradient of the edge layer is converted to a monotonically decreasing activation gradient (called the locational gradient) in the feature layer. The activation level is highest for the first letter and decreases across the string. Hemisphere-specific processing is necessary because the acuity gradient does not match the locational gradient in the first half of a fixated word (i.e., acuity increases from the first letter to the fixated letter and the locational gradient decreases across the string), whereas the acuity gradient and locational gradient match in the second half of the word (i.e., both decreasing). Strong directional lateral inhibition is required in the hemisphere (for left-to-right languages—Right Hemisphere [RH]) contralateral to the first half of the word (for left-to-right languages—Left Visual Field [LVF]), in order to invert the acuity gradient.

At the letter layer, corresponding to the posterior fusiform gyms, letter units fire serially due to the interaction of the activation gradient with oscillatory letter nodes (see above feature layer). That is, the letter unit encoding the first letter fires, then the unit encoding the second letter fires, etc. This mechanism is based on the general proposal that item order is encoded in successive gamma cycles 60 Hz of a theta cycle 5 Hz (Lisman, J. E., & Idiart, M. A. P. (1995), Storage of 7±2 short-term memories in oscillatory subcycles, Science, 267, 1512-1515). Lisman and Idiart have proposed related mechanisms for precisely controlling spike timing, in which nodes undergo synchronous, sub-threshold oscillations of excitability. The amount of input to these nodes then determines the timing of firing with respect to this oscillatory cycle. That is, each activated letter unit fires in a burst for about 15 ms (one gamma cycle), and bursting repeats every 200 ms (one theta cycle). Activated letter units burst slightly out of phase with each other, such that they fire in a rapid sequence. This firing rapid sequence encoding (seriality) is the key point of abstraction.

In the present SERIOL model, the retinotopic presentation is mapped onto a temporal representation (space is mapped onto time) to create an abstract, invariant representation that provides a location-invariant representation of letter order. This abstract serial encoding provides input to both the lexical and sub-lexical routes. It is assumed that the sub-lexical route parses and translates the sequence of letters into a grapho-phonological encoding (Whitney, C., & Cornelissen, P. (2005), Letter-position encoding and dyslexia, Journal of Research in Reading, 28, 274-301). The resulting representation encodes syllabic structure and records which graphemes generated which phonemes. The remaining layers of the model address processing that is specific to the lexical route.

At the open-bigram layer, corresponding to the left middle fusiform, letter units recognize pairs of letter units that fire in a particular order (Grainger, J., & Whitney, C. (2004), Does the huamn mnid raed wrods as a whole?, Trends in Cognitive Sciences, 8, 58-59). For example, open-bigram unit XY is activated when letter unit X fires before Y, where the letters x and y were not necessarily contiguous in the string. The activation of an open-bigram unit decreases with increasing time between the firing of the constituent letter units. Thus, the activation of open-bigram XY is highest when triggered by contiguous letters, and decreases as the number of intervening letters increases. Priming data indicates that the maximum separation is likely to be two letters (Schoonbaert, S., & Grainger, J. (2004), Letter position coding in printed word perception: Effects of repeated and transposed letters, Language and Cognitive Processes, 19, 333-367). Open-bigram activations depend only on the distance between the constituent letters (Whitney, C. (2004a), Investigations into the neural basis of structured representations, Doctoral Dissertation. University of Maryland).

Still, following the evidence for a special role for external letters, the string is anchored to those endpoints via edge open-bigrams; whereby edge units explicitly encode the first and last letters (Humphreys, G. W., Evett, L. J., & Quinlan, P. T. (1990), Orthographic processing in visual word identification, Cognitive Psychology, 22, 517-560). For example, the encoding of the stimulus CART would be *C (open-bigram *C is activated when letter C is preceded by a space), CA, AR, CR, RT, AT, CT, and T* (open-bigram *T is activated when letter T is followed by a space), where * represents an edge or space. In contrast to other open-bigrams inside the string, an edge open-bigram cannot become partially activated (e.g., by the second or next-to-last letter).

At the word layer, the open-bigram units attach via weighted connections. The input to a word unit is represented by the dot-product of its respective number of open-bigram unit activations and the weighted connections to those open-bigrams units. Stated another way, it is the dot-product of the open-bigram unit's activation vector and the connection of the open-bigrams unit's weight vector. Commonly in neural networks models, the normalization of vector connection weights is assumed such that open-bigrams making up shorter words have higher connections weights than open-bigrams making up longer words. For example, the connection weights from CA, AN, and CN to the word-unit CAN are larger than the connections weights to the word-unit CANON. Hence, the stimulus can/would activate CAN more than CANON.

### Visual Perceptual Patterns

The SERIOL model assumes that the feature layer is comprised of features that are specific to alphanumeric—string serial processing. A stimulus would activate both alphanumeric-specific and general features. Alphanumeric-specific features would be subject to the locational gradient, while general features would reflect acuity. Alphanumeric-specific-features that activate alphanumeric representations would show the effects of string-specific serial processing. In particular, there will be an advantage if the letter or number character is the initial or last character of a string. However, if the symbol is not a letter or a number character, the alphanumeric-specific features will not activate an alphanumeric representation and there will be no alphanumeric-specific effects. Rather, the symbol will be recognized via the general visual features, where the effect of acuity predominates. An initial or last symbol in the string will be at a disadvantage because its acuity is lower than the acuity for the internal symbols in the string.

Two studies have examined visual perceptual patterns for letters versus non-alphanumeric characters in strings of centrally presented stimuli, using a between-subjects design for the different stimulus types (Hammond, E. J., & Green, D. W. (1982), Detecting targets in letter and non-letter arrays, Canadian Journal of Psychology, 36, 67-82). Both studies found an external-character advantage for letters. Specifically, the first and last letter characters were processed more efficiently than the internal letters characters. Mason also showed an external-character advantage for number strings (Mason, M. (1982), Recognition time for letters and non-letters: Effects of serial position, array size, and processing order, Journal of Experimental Psychology: Human Perception and Performance, 8, 724-738). However, both studies found that the advantage was absent for non-alphanumeric characters. The first and last symbol in a string were processed the least well in line with their lower acuity.

Using fixated strings containing both letters and non-alphanumeric characters, Tydgat and Grainger showed that an initial letter character in a string had a visual recognition advantage while an initial symbol (non-alphanumeric character) in the string did not. Thus, symbols that do not normally occur in strings show a different visual perceptual pattern than alphanumeric characters (Tydgat, I., and Grainger, J. (2009), Serial position effects in the identification of letters, digits, and symbols, J. Exp. Psychol. Hum. Percept. Perform. 35, 480-498). As described in more detail by Whitney & Cornelissen, the SERIOL model explains these visual perceptual patterns (Whitney, C., & Cornelissen, P. (2005), Letter-position encoding and dyslexia, Journal of Research in Reading, 28, 274-301; Whitney, C. (2001a), How the brain encodes the order of letters in a printed word: The SERIOL model and selective literature review, Psychonomic Bulletin and Review, 8, 221-243; Whitney, C. (2008), Supporting the serial in the SERIOL model, Lang. Cogn. Process. 23, 824-865; and Whitney, C., & Cornelissen, P. (2005), Letter-position encoding and dyslexia, Journal of Research in Reading, 28, 274-301).

The external letter character advantage arises as follows. An advantage for the initial letter character in a string comes from the directional inhibition at the (retinotopic) feature level, because the initial letter character is the only letter character that does not receive lateral inhibition. An advantage for the final letter character arises at the (abstract) letter layer level, because the firing of the last letter character in a string is not terminated by a subsequent letter character. This serial positioning processing is specific to alphanumeric strings, thus explaining the lack of external character visual perceptual advantage for non-alphanumeric characters.

### Letter Position Parallel Encoding: The Grainger & Van Heuven Model

According to the Grainger and van Heuven model, parallel mapping of visual feature information at a specific location along the horizontal meridian with respect to eye fixation is mapped onto abstract letter representations that code for the presence of a given letter identity at that particular location (Grainger, J., & van Heuven, W. J. B. (2003), Modeling letter position coding in printed word perception, In P. Bonin (Ed.), Mental lexicon: “Some words to talk about words” (pp. 1-24). New York, N.Y.: Nova Science). In other words, this model proposes an “alphabetic array” retinotopic encoding consisting in a hypothesized bank of letter detectors that perform parallel, independent letter identification (any given letter has a separate representation for each retinal location). Grainger and van Heuven further proposed that these letters detectors are assumed to be invariant to the physical characteristics of letters and that these abstract letter representations are thought to be activated equally well by the same letter written in different case, in a different font, or a different size, but not invariant to position.

The next stage of processing, referred to as the “relative-position map”, is thought to code for the relative (within-stimulus) position of letters identities independently of their shape and their size, and independently of the location of the stimulus word (location invariance). This location-specific coding of letter identities is then transformed into a location invariant pre-lexical orthographic code (the relative-position map) before matching this information with whole-word orthographic representations in long-term memory. In essence, the relative-position map abstracts away from absolute letter position and focuses instead on relationships between letters. Therefore, in this model, the retinotopic alphabetic array is converted in parallel into an abstract open-bigram encoding that brings into play implicit relationships between letters. Specifically, this is achieved by open-bigram units that receive activation from the alphabetic array such that a given letter order D-E that is realized at any possible combinations of location in the retinotopic alphabetic array, activates the corresponding abstract open bigram for that sequence. Still, abstract open bigrams are activated by letter pairs that have up to two intervening letters. The abstract open-bigrams units then connect to word units. A key distinguishing virtue of this specific approach to letter position encoding rests on the assumption/claim that flexible orthographic coding is achieved by coding for ordered combinations of contiguous and non-contiguous letters pairs.

### Relationships Between Letters in a String—Coding Non-Contiguous Letter Combinations

Currently, there is a general consensus that the literate brain executes some form of word-centered, location-independent, orthographic coding such that letter identities are abstractly coded for their position in the word independent of their position on the retina (at least for words that require a single fixation for processing). This consensus also holds true for within-word position coding of letters identities to be flexible and approximate. In other words, letter identities are not rigidly allocated to a specific position. The corroboration for such flexibility and approximate orthographic encoding has been mainly classically obtained by utilizing the masked priming paradigm: for a given number of letters shared by the prime and target, priming effects are not affected by small changes of letter order (flexible and approximate letter position encoding)—transposed letter (TL) priming (Perea, M., and Lupker, S. J. (2004), Can CANISO activate CASINO? Transposed-letter similarity effects with nonadjacent letter positions, J. Mem. Lang. 51, 231-246; and Schoonbaert, S., and Grainger, J. (2004), Letter position coding in printed word perception: effects of repeated and transposed letters, Lang. Cogn. Process. 19, 333-367), and length-dependent letter position—relative-position priming (Peressotti, F., and Grainger, J. (1999), The role of letter identity and letter position in orthographic priming, Percept. Psychophys. 61, 691-706; and Grainger, J., Granier, J. P., Farioli, F., Van Assche, E., and van Heuven, W. J. B. (2006), Letter position information and printed word perception: the relative-position priming constraint, J. Exp. Psychol. Hum. Percept. Perform. 32, 865-884).

Yet, the claim for a flexible and approximate orthographic encoding has extended to be also achieved by coding for letter combinations (Whitney, C., and Berndt, R. S. (1999), A new model of letter string encoding: simulating right neglect dyslexia, in Progress in Brain Research, eds J. A. Reggia, E. Ruppin, and D. Glanzman (Amsterdam: Elsevier), 143-163; Whitney, C. (2001), How the brain encodes the order of letters in a printed word: the SERIOL model and selective literature review, Psychon. Bull. Rev. 8, 221-243; Grainger, J., and van Heuven, W. J. B. (2003), Modeling letter position coding in printed word perception, in The Mental Lexicon, ed. P. Bonin (New York: Nova Science Publishers), 1-23; Dehaene, S., Cohen, L., Sigman, M., and Vinckier, F. (2005), The neural code for written words: a proposal, Trends Cogn. Sci. (Regul. Ed.) 9, 335-341). Letter combinations are classically and exclusively demonstrated by the use of contiguous letter combinations in n-gram coding and in particular by the use of non-contiguous letter combinations in n-gram coding. Dehaene has proposed that the coding of non-contiguous letter combinations arises as an artifact because of noisy erratic position retinotopic coding in location-specific letters detectors (Dehaene, S., Cohen, L., Sigman, M., and Vinckier, F. (2005), The neural code for written words: a proposal, Trends Cogn. Sci. (Regul. Ed.) 9, 335-341). In this scheme, the additional flexibility in orthographic encoding arises by accident, but the resulting flexibility is utilized to capture key data patterns.

In contrast, Dandurant has taken a different perspective, proposing that the coding of non-contiguous letter combinations is deliberate, and not the result of inaccurate location-specific letter coding (Dandurant F., Grainger, J., Dunabeitia, J. A., & Granier, J.-p. (2011), On coding non-contiguous letter combinations, Frontiers in Psychology, 2(136), 1-12. Doi:10.3389/fpsyg.2011.00136). In other words, non-contiguous letter combinations are coded because they are beneficial with respect to the overall goal of mapping letters onto meaning, not because the system is intrinsically noisy and therefore imprecise to determine the exact location of letters in a string. Dandurant et al., have examined two kinds of constrains that a reader should take into consideration when optimally processing orthographic information: 1) variations in letter visibility across the different letters of a word during a single fixation and 2) varying amount of information carried by the different letters in the word (e.g., consonants versus vowels letters). More specifically, they have hypothesized that this orthographic processing optimization would involve coding of non-contiguous letters combinations.

The reason for optimal processing of non-contiguous letter combinations can be explained on the following basis: 1) when selecting an ordered subset of letters which are critical to the identification of a word (e.g., the word “fatigue” can be uniquely identified by ordered letters substrings “ftge” and “atge” which result from dropping non-essential letters that bear little information), about half of the letters in the resulting subset are non-contiguous letters; and 2) the most informative pair of letters in a word is a non-contiguous pair of letters combination in 83% of 5-7 letter words (having no letter repetition) in English, and 78% in French and Spanish (the number of words included in the test set were 5838 in French, 8412 in English, and 4750 in Spanish) (Dandurant F., Grainger, J., Dunabeitia, J. A., & Granier, J.-p. (2011), On coding non-contiguous letter combinations, Frontiers in Psychology, 2(136), 1-12. Doi:10.3389/fpsyg.2011.00136). In summary, they concluded that an optimal and rational agent learning to read corpuses of real words should deliberately code for non-contiguous pair of letters (open-bigrams) based on informational content and given letters visibility constrains (e.g., initial, middle and last letters in an string of letters are more visually perceptually visible).

### Different Serial Position Effects in the Identification of Letters, Digits, and Symbols

In languages that use alphabetical orthographies, the very first stage of the reading process involves mapping visual features onto representations of the component letters of the currently fixated word (Grainger, J., Tydgat, I., and Isselé, J. (2010), Crowding affects letters and symbols differently, J. Exp. Psychol. Hum. Percept. Perform. 36, 673-688). Comparison of serial position functions using the target search task for letter stimuli versus symbol stimuli or simple shapes showed that search times for a target letter in a string of letters are represented by an approximate M-shape serial position function, where the shortest reaction times (RTs) were recorded for the first, third and fifth positions of a five-letter string (Estes, W. K., Allmeyer, D. H., & Reder, S. M. (1976), Serial position functions for letter identification at brief and extended exposure durations, Perception & Psychophysics, 19, 1-15). In contrast, a 5-symbol string (e.g., $, %, &) and shape stimuli shows a U-shape function with shortest RTs for targets at the central position on fixation that increase as a function of eccentricity (Hammond, E. J., & Green, D. W. (1982), Detecting targets in letter and non-letter arrays, Canadian Journal of Psychology, 36, 67-82).

A definitive interpretation of the different effect serial position has on letters and symbols is that it reflects the combination of two factors: 1) the drop of acuity from fixation to the periphery, and 2) less crowding on the first and last letter of the string because these letters are flanked by only one other letter (Bouma, H. (1973), Visual interference in the parafoveal recognition of initial and final letters of word, Vision Research, 13, 762-82). Specifically expanding on the second factor, Tydgat and Grainger proposed that crowding effects may be more limited in spatial extent for letter and number stimuli compared with symbol stimuli, such that a single flanking stimulus would suffice to generate almost maximum interference for symbols, but not for letters and numbers (Tydgat, I., and Grainger, J. (2009), Serial position effects in the identification of letters, digits, and symbols, J. Exp. Psychol. Hum. Percept. Perform. 35, 480-498). According to the Tydgat and Grainger interpretation of the different serial position functions for letters and symbols, one should be able to observe differential crowding effects for letters and symbols in terms of a superior performance at the first and last positions for letter stimuli but not for symbols or shapes stimuli. In a number of experiments they tested the hypothesis that a reduction in size of integration fields at the retinotopic layer, specific to stimuli that typically appear in strings (letters and digits), results in less crowding for such stimuli compared with other types of visual stimuli such as symbols and geometric shapes. In other words, the larger the integration field involved in identifying a given target at a given location, the greater the number of features from neighboring stimuli that can interfere in target identification. Stated another way, letter and digit stimuli benefit from a greater release from crowding effects (flanking letters or digits) at the outer positions than do symbol and geometric shape stimuli.

Still, critical spacing was found to be smaller for letters than for other symbols, with letter targets being identified more accurately than symbol targets at the lowest levels of inter-character spacing (manipulation of target-flankers spacing showed that symbols required a greater degree of separation [larger critical spacing] than letters in order to reach a criterion level of identification) (See experiment 5, Grainger, J., Tydgat, I., and Isselé, J. (2010), Crowding affects letters and symbols differently, J. Exp. Psychol. Hum. Percept. Perform. 36, 673-688). Most importantly, differential serial position crowding effects are of great importance given the fact that performance in the Two-Alternative Forced-Choice Procedure of isolated symbols and letters was very similar (Grainger, J., Tydgat, I., and Isselé, J. (2010), Crowding affects letters and symbols differently, J. Exp. Psychol. Hum. Percept. Perform. 36, 673-688).

Concerning the potential mechanism of crowding effects, Grainger et al. proposed bottom-up mechanisms whose operation can vary as a function of stimulus type via off-line as opposed to on-line influences. These off-line influences of stimulus type involved differences in perceptual learning driven by differential exposure to the different types of stimuli. Further, they proposed that when children learn to read, a specialized system develops in the visual cortex to optimize processing in the extremely crowded conditions that arise with printed words and numeric strings (e.g., in a two-stage retinotopic processing model: in the first-stage there is a detection of simple features in receptive fields of V1—0.1 ø and in a second-stage there is integration/interpretation in receptive fields of V4—0.5 ø [neurons in V4 are modulated by attention]) (See Levi, D. M., (2008), Crowding—An essential bottleneck for object recognition: A mini-review, Vision Research, 48, 635-654).

The central tenant here is that receptive field size of retinotopic letter and digit detectors has adapted to the need to optimize processing of strings of letters and digits and that the smaller the receptive field size of these detectors, the less interference there is from neighboring characters. One way to attain such processing optimization is being explained as a reduction in the size and shape of “integration fields.” The “integration field” is equivalent to a second-stage receptive field that combines the features by the earlier stage into an (object) alphanumeric character associated with location-specific letter detectors, “the alphabetic array”, that perform parallel letter identification compared with other visual objects that do not typically occur in such a cluttered environment (Dehaene, S., Cohen, L., Sigman, M., and Vinckier, F. (2005), The neural code for written words: a proposal, Trends Cogn. Sci. (Regul. Ed.) 9, 335-341; Grainger, J., Granier, J. P., Farioli, F., Van Assche, E., and van Heuven, W. J. B. (2006), Letter position information and printed word perception: the relative-position priming constraint, J. Exp. Psychol. Hum. Percept. Perform. 32, 865-884; and Grainger, J., and van Heuven, W. J. B. (2003), Modeling letter position coding in printed word perception, in The Mental Lexicon, ed. P. Bonin (New York: Nova Science Publishers), 1-23).

Ktori, Grainger, Dufau provided further evidence on differential effects between letters and symbols stimuli (Maria Ktori, Jonathan Grainger & Stéphan Dufau (2012), Letter string processing and visual short-term memory, The Quarterly Journal of Experimental Psychology, 65:3, 465-473). They study how expertise affects visual short-term memory (VSTM) item storage capacity and item encoding accuracy. VSTM is recognized as an important component of perceptual and cognitive processing in tasks that rest on visual input (Prime, D., & Jolicoeur, P. (2010), Mental rotation requires visual short-term memory: Evidence from human electric cortical activity, Journal of Cognitive Neuroscience, 22, 2437-2446). Specifically, Prime and Jolicoeur investigated whether the spatial layout of letters making up a string affects the accuracy with which a group of proficient adult readers performed a change-detection task (Luck, S. J. (2008), Visual short-term memory, In S. J. Luck & A. Hollingworth (Eds.), Visual memory (pp. 43-85). New York, N.Y.: Oxford University Press), item arrays that varied in terms of character type (letters or symbols), number of items (3, 5, and 7), and type of display (horizontal, vertical and circular) are used. Study results revealed an effect of stimulus familiarity significantly noticeable in more accurate change-detection responses for letters than for symbols. In line with the hypothesized experimental goals in the study, they found evidence that supports that highly familiar items, such as arrays of letters, are more accurately encoded in VSTM than unfamiliar items, such as arrays of symbols. More so, their study results provided additional evidence that expertise is a key factor influencing the accuracy with which representations are stored in VSTM. This was revealed by the selective advantage shown for letter over symbol stimuli when presented in horizontal compared to vertical or circular displays formats. The observed selective advantage of letters over symbols can be the result of years of reading that leads to expertise in processing horizontally aligned strings of letters so as to form word units in alphabetic languages such as English, French and Spanish.

In summary, the study findings support the argument that letter string processing is significantly influenced by the spatial layout of letters in strings in perfect agreement with other studies findings conducted by Grainger & van Heuven (Grainger, J., & van Heuven, W. J. B. (2003), Modeling letter position coding in printed word perception, In P. Bonin (Ed.), Mental lexicon: “Some words to talk about words”. New York, N.Y.: Nova Science Publishers and Tydgat, I., & Grainger, J. (2009), Serial position effects in the identification of letters, digits and symbols, Journal of Experimental Psychology: Human Perception and Performance, 35, 480-498).

Open Proto-Bigrams Embedded within Words (Subset Words) and as Standalone Connecting Word in-Between Words

A number of computational models have postulated open-bigrams as best means to substantiate a flexible orthographic encoding capable of explaining TL and RP priming effects. In the Grainger & van Heuven model the retinotopic alphabetic array is converted in parallel into an abstract open-bigram encoding that brings into play implicit relationships between letters (e.g., contiguous and non-contiguous) (Grainger, J., & van Heuven, W. J. B. (2003), Modeling letter position coding in printed word perception, In P. Bonin (Ed.), Mental lexicon: “Some words to talk about words”. New York, N.Y.: Nova Science Publishers). In the SERIOL model retinotopic visual stimuli presentation is mapped onto a temporal one where letter units recognize pairs of letter units (an open-bigram) that fire in a particular serial order; namely, space is mapped onto time to create an abstract invariant representation providing a location-invariant representation of letter order in a string (Whitney, C. (2001a), How the brain encodes the order of letters in a printed word: The SERIOL model and selective literature review, Psychonomic Bulletin and Review, 8, 221-243; Whitney, C. (2008), Supporting the serial in the SERIOL model, Lang. Cogn. Process. 23, 824-865; and Whitney, C., and Cornelissen, P. (2005), Letter-position encoding and dyslexia, J. Res. Read. 28, 274-301). In these models, open-bigrams represent an abstract intermediary layer between letters and word units.

A key distinguishing virtue of this specific approach to letter position encoding rests on that flexible orthographic coding is achieved by coding for ordered combinations of contiguous and non-contiguous letters pairs, namely open-bigrams. For example, in the English language there are 676 pairs of letters combinations or open-bigrams (see Table 1 below). In addition to studies that have shown open-bigrams information processing differences between pair of letters entailing CC, VV, VC or CV, we introduce herein an additional open-bigrams novel property that should be interpreted as causing an automatic direct cascaded spread activation effect from orthography to semantics. Specifically, an open-bigram of the form VC or CV that is also a word carrying a semantic meaning such as for example: AM, AN, AS, AT, BE, BY, DO, GO, HE, IF, IN, IS, IT, ME, MY, NO, OF, ON, OR, SO, TO, UP, US, WE, is herein dubbed “open proto-bigram”. Still, these 24 open proto-bigrams that are also words represent 3.55% of all open-bigrams obtained from the English Language alphabet (see Table 1 below). Open proto-bigrams that are a subset word e.g., “BE” embedded in a word e.g., “BELOW” or are a subset word “HE” embedded in a superset word e.g., “SHE” or “THE” would not only indicate that the orthographic or phonological forms of the subset open proto-bigram word “HE” in the superset word “SHE” or “THE” or the subset open proto-bigram word “BE” in the word “BELOW” were activated in parallel, but also that these co-activated word forms triggered automatically and directly their corresponding semantic representations during the course of identifying the orthographic form of the word.

Based on the herein presented literature and novel teachings of the present subject matter, it is further assumed that this automatic bottom-up-top-down orthographic parallel-serial informational processing handshake, manifests in a direct cascade effect providing a number of advantages, thus facilitating the following perceptual-cognitive process: 1) fast lexical-sub-lexical recognition, 2) maximal chunking (data compression) of number of items in VSTM, 3) fast processing, 4) solid consolidation encoding in short-term memory (STM) and long-term memory (LTM), 5) fast semantic track for extraction/retrieval of word literal meaning, 6) less attentional cognitive taxing, 7) most effective activation of neighboring word forms, including multi-letter graphemes (e.g., th, ch) and morphemes (e.g., ing, er), 8) direct fast word recall that strongly inhibits competing or non-congruent distracting word forms; and 9) for a proficient reader, when open proto-bigrams are a standalone connecting a word unit in between words in a sentence, there is no need for (open proto-bigram) orthographic lexical pattern recognition and retrieval of their corresponding semantic literal information due to their super-efficient maximal chunking (data compression) and robust consolidation in STM-LTM. Namely, standalone open proto-bigrams connecting words in between words in sentences are automatically known implicitly. Thus, a proficient reader may also not consciously and explicitly pay attention to them and will therefore remain minimally aroused to their visual appearance.

TABLE 1
Open-Bigrams of the English Language

| | | | | | | | | | | | | | | | | | | | | | | | | | |
|---|---|---|---|---|---|---|---|---|---|---|---|---|---|---|---|---|---|---|---|---|---|---|---|---|---|
| aa | ab | ac | ad | ae | af | ag | ah | ai | aj | ak | al | am | an | ao | ap | aq | ar | as | at | au | av | aw | ax | ay | az |
| ba | bb | bc | bd | be | bf | bg | bh | bi | bj | bk | bl | bm | bn | bo | bp | bq | br | bs | bt | bu | bv | bw | bx | by | bz |
| ca | cb | cc | cd | ce | cf | cg | ch | ci | cj | ck | cl | cm | cn | co | cp | cq | cr | cs | ct | cu | cv | cw | cx | cy | cz |
| da | db | dc | dd | de | df | dg | dh | di | dj | dk | dl | dm | dn | do | dp | dq | dr | ds | dt | du | dv | dw | dx | dy | dz |
| ea | eb | ec | ed | ee | ef | eg | eh | ei | ej | ek | el | em | en | eo | ep | eq | er | es | et | eu | ev | ew | ex | ey | ez |
| fa | fb | fc | fd | fe | ff | fg | fh | fi | fj | fk | fl | fm | fn | fo | fp | fq | fr | fs | ft | fu | fv | fw | fx | fy | fz |
| ga | gb | gc | gd | ge | gf | gg | gh | gi | gj | gk | gl | gm | gn | go | gp | gq | gr | gs | gt | gu | gv | gw | gx | gy | gz |
| ha | hb | hc | hd | he | hf | hg | hh | hi | hj | hk | hl | hm | hn | ho | hp | hq | hr | hs | ht | hu | hv | hw | hx | hy | hz |
| ia | ib | ic | id | ie | if | ig | ih | ii | ij | ik | il | im | in | io | ip | iq | ir | is | it | iu | iv | iw | ix | iy | iz |
| ja | jb | jc | jd | je | jf | jg | jh | ji | jj | jk | jl | jm | jn | jo | jp | jq | jr | js | jt | ju | jv | jw | jx | jy | jz |
| ka | kb | kc | kd | ke | kf | kg | kh | ki | kj | kk | kl | km | kn | ko | kp | kq | kr | ks | kt | ku | kv | kw | kx | ky | kz |
| la | lb | lc | ld | le | lf | lg | lh | li | lj | lk | ll | lm | ln | lo | lp | lq | lr | ls | lt | lu | lv | lw | lx | ly | lz |
| ma | mb | mc | md | me | mf | mg | mh | mi | mj | mk | ml | mm | mn | mo | mp | mq | mr | ms | mt | mu | mv | mw | mx | my | mz |
| na | nb | nc | nd | ne | nf | ng | nh | ni | nj | nk | nl | nm | nn | no | np | nq | nr | ns | nt | nu | nv | nw | nx | ny | nz |
| oa | ob | oc | od | oe | of | og | oh | oi | oj | ok | ol | om | on | oo | op | oq | or | os | ot | ou | ov | ow | ox | oy | oz |
| pa | pb | pc | pd | pe | pf | pg | ph | pi | pj | pk | pl | pm | pn | po | pp | pq | pr | ps | pt | pu | pv | pw | px | py | pz |
| qa | qb | qc | qd | qe | qf | qg | qh | qi | qj | qk | ql | qm | qn | qo | qp | qq | qr | qs | qt | qu | qv | qw | qx | qy | qz |
| ra | rb | rc | rd | re | rf | rg | rh | ri | rj | rk | rl | rm | rn | ro | rp | rq | rr | rs | rt | ru | rv | rw | rx | ry | rz |
| sa | sb | sc | sd | se | sf | sg | sh | si | sj | sk | sl | sm | sn | so | sp | sq | sr | ss | st | su | sv | sw | sx | sy | sz |
| ta | tb | tc | td | te | tf | tg | th | ti | tj | tk | tl | tm | tn | to | tp | tq | tr | ts | tt | tu | tv | tw | tx | ty | tz |
| ua | ub | uc | ud | ue | uf | ug | uh | ui | uj | uk | ul | um | un | uo | up | uq | ur | us | ut | uu | uv | uw | ux | uy | uz |
| va | vb | vc | vd | ve | vf | vg | vh | vi | vj | vk | vl | vm | vn | vo | vp | vq | vr | vs | vt | vu | vv | vw | vx | vy | vz |
| wa | wb | wc | wd | we | wf | wg | wh | wi | wj | wk | wl | wm | wn | wo | wp | wq | wr | ws | wt | wu | wv | ww | wx | wy | wz |
| xa | xb | xc | xd | xe | xf | xg | xh | xi | xj | xk | xl | xm | xn | xo | xp | xq | xr | xs | xt | xu | xv | xw | xx | xy | xz |
| ya | yb | yc | yd | ye | yf | yg | yh | yi | yj | yk | yl | ym | yn | yo | yp | yq | yr | ys | yt | yu | yv | yw | yx | yy | yz |
| za | zb | zc | zd | ze | zf | zg | zh | zi | zj | zk | zl | zm | zn | zo | zp | zq | zr | zs | zt | zu | zv | zw | zx | zy | zz |

### Open Proto-Bigrams Words as Standalone Function Words in Between Words in Alphabetic Languages

Open-bigrams that are words (herein termed “open proto-bigrams), as for example: AM, AN, AS, AT, BE, BY, DO, GO, HE, IF, IN, IS, IT, ME, MY, NO, OF, ON, OR, SO, TO, UP, US, WE, belong to a linguistic class named ‘function words’. Function words either have reduced lexical or ambiguous meaning. They signal the structural grammatical relationship that words have to one another and are the glue that holds sentences together. Function words also specify the attitude or mood of the speaker. They are resistant to change and are always relatively few (in comparison to ‘content words’). Accordingly, open proto-bigrams (and other n-grams e.g. “THE”) words may belong to one or more of the following function words classes: articles, pronouns, adpositions, conjunctions, auxiliary verbs, interjections, particles, expletives and pro-sentences. Still, open proto-bigrams that are function words are traditionally categorized across alphabetic languages as belonging to a class named ‘common words’. In the English language, there are about 350 common words which stand for about 65-75% of the words used when speaking, reading and writing. These 350 common words satisfy the following criteria: 1) they are the most frequent/basic words of an alphabetic language; 2) they are the shortest words—up to 7 letters per word; and 3) they cannot be perceptually identified (access to their semantic meaning) by the way they sound; they must be recognized visually, and therefore are also named ‘sight words’.

Frequency Effects in Alphabetical Languages for: 1) Open Bigrams and 2) Open Proto-Bigrams Function Words as: a) Standalone Function Words in Between Words and b) as Subset Function Words Embedded within Words

Fifty to 75% of the words displayed on a page or articulated in a conversation are frequent repetitions of most common words. Just 100 different most common words in the English language (see Table 2 below) account for a remarkable 50% of any written text. Further, it is noteworthy that 22 of the above-mentioned open proto-bigrams function words are also most common words that appear within the 100 most common words, meaning that on average one in any two spoken or written words would be one of these 100 most common words. Similarly, the 350 most common words account for 65% to 75% of everything written or spoken, and 90% of any average written text or conversation will only need a vocabulary of common 7,000 words from the existing 1,000,000 words in the English language.

TABLE 2
Most Frequently Used Words Oxford Dictionary 11^{Th} Edition

| | |
|---|---|
| 1. | the |
| 2. | be |
| 3. | to |
| 4. | of |
| 5. | and |
| 6. | a |
| 7. | in |
| 8. | that |
| 9. | have |
| 10. | I |
| 11. | it |
| 12. | for |
| 13. | not |
| 14. | on |
| 15. | with |
| 16. | he |
| 17. | as |
| 18. | you |
| 19. | do |
| 20. | at |
| 21. | this |
| 22. | but |
| 23. | his |
| 24. | by |
| 25. | from |
| 26. | they |
| 27. | we |
| 28. | say |
| 29. | her |
| 30. | she |
| 31. | or |
| 32. | an |
| 33. | will |
| 34. | my |
| 35. | one |
| 36. | all |
| 37. | would |
| 38. | there |
| 39. | their |
| 40. | what |
| 41. | so |
| 42. | up |
| 43. | out |
| 44. | if |
| 45. | about |
| 46. | who |
| 47. | get |
| 48. | which |
| 49. | go |
| 50. | me |
| 51. | when |
| 52. | make |
| 53. | can |
| 54. | like |
| 55. | time |
| 56. | no |
| 57. | just |
| 58. | him |
| 59. | know |
| 60. | take |
| 61. | person |
| 62. | into |
| 63. | year |
| 64. | your |
| 65. | good |
| 66. | some |
| 67. | could |
| 68. | them |
| 69. | see |
| 70. | other |
| 71. | than |
| 72. | then |
| 73. | now |
| 74. | look |
| 75. | only |
| 76. | come |
| 77. | its |
| 78. | over |
| 79. | think |
| 80. | also |
| 81. | back |
| 82. | after |
| 83. | use |
| 84. | two |
| 85. | how |
| 86. | our |
| 87. | work |
| 88. | first |
| 89. | well |
| 90. | way |
| 91. | even |
| 92. | new |
| 93. | want |
| 94. | because |
| 95. | any |
| 96. | these |
| 97. | give |
| 98. | day |
| 99. | most |
| 100. | us |

Most Frequently Used Words Oxford Dictionary 11^{th} Edition

Still, it is noteworthy that a large number of these 350 most common words entail 1 or 2 open pro-bigrams function words as embedded subset words within the most common word unit (see Table 3 below).

TABLE 3
Common Service and Nouns Words List
By: Edward William Dolch - Problems in Reading 1948
Dolch Word List Sorted Alphabetically by Grade with Nouns

| Pre-primer | Primer | First | Second | Third | Nouns | Nouns |
|---|---|---|---|---|---|---|
| a | all | after | always | about | apple | home |
| and | am | again | around | better | baby | horse |
| away | are | an | because | bring | back | house |
| big | at | any | been | carry | ball | kitty |
| blue | ate | as | before | clean | bear | leg |
| can | be | ask | best | cut | bed | letter |
| come | black | by | both | done | bell | man |
| down | brown | could | buy | draw | bird | men |
| find | but | every | call | drink | birthday | milk |
| for | came | fly | cold | eight | boat | money |
| funny | did | from | does | fall | box | morning |
| go | do | give | don't | far | boy | mother |
| help | eat | going | fast | full | bread | name |
| here | four | had | first | got | brother | nest |
| I | get | has | five | grow | cake | night |
| in | good | her | found | hold | car | paper |
| is | have | him | gave | hot | cat | party |
| it | he | his | goes | hurt | chair | picture |
| jump | into | how | green | if | chicken | Pig |
| little | like | just | its | keep | children | rabbit |
| look | must | know | made | kind | Christmas | rain |

The teachings of the present subject matter are in perfect agreement with the fact that the brain's anatomical architecture constrains its perceptual-cognitive functional abilities and that some of these abilities become non-stable, decaying or atrophying with age. Indeed, slow processing speed, limited memory storage capacity, lack of sensory-motor inhibition and short attentional span and/or inattention, to mention a few, impose degrees of constrains upon the ability to visually, phonologically and sensory-motor implicitly pick-up, explicitly learn and execute the orthographic code. However, there are a number of mechanisms at play that develop in order to impose a number of constrains to compensate for limited motor-perceptual-cognitive resources. As previously mentioned, written words are visual objects before attaining the status of linguistic objects as has been proposed by McCandliss, Cohen, & Dehaene (McCandliss, B., Cohen, L., & Dehaene, S. (2003), The visual word form area: Expertise for reading in the fusiform gyrus, Trends in Cognitive Sciences, 13, 293-299) and there is pre-emption of visual object processing mechanisms during the process of learning to read (See also Dehaene et al., Local Combination Detector (LCD) model, Dehaene, S., Cohen, L., Sigman, M., and Vinckier, F. (2005), The neural code for written words: a proposal, Trends Cogn. Sci. (Regul. Ed.) 9, 335-341). In line with the latter, Grainger and van Heuven's alphabetic array is one such mechanism, described as a specialized system developed specifically for the processing of strings of alphanumeric stimuli (Grainger, J., & van Heuven, W. J. B. (2003), Modeling letter position coding in printed word perception, In P. Bonin (Ed.), Mental lexicon: “Some words to talk about words”. New York, N.Y.: Nova Science Publishers).

Another such mechanism at work is the high lexical-phonological information redundancies conveyed in speech and also found in the lexical components of an alphabetic language orthographic code. For example, relationships among letter combinations within a string and in between strings reflect strong letter combinations redundancies. Thus, the component units of the orthographic code implement frequent repetitions of some open bigrams in general and of all open proto-bigrams (that are words) in particular. In general, lexical and phonological redundancies in speech production and lexical redundancies in writing as reflected in frequent repetitions of some open bigrams and all open proto-bigrams within a string (a word) and among strings (words) in sentences reduces content errors in sender production of written-spoken messages making the spoken phonological-lexical message or orthographic code message resistant to noise or irrelevant contextual production substitutions, thereby increasing the interpretational semantic probability to comprehending the received message in its optimal context by the receiver.

Despite the above-mentioned brain anatomical constrains on function and related limited motor-perceptual-cognitive resources and how these constrains impact the handling of orthographic information, the co-occurrence of some open-bigrams and all open proto-bigrams in alphabetic languages renders alongside other developed compensatory specialized mechanisms at work (e.g. alphabetic array) an offset strategy that implements age-related, fast, coarse-lexical pattern recognition, maximal chunking (data compression) and optimal manipulation of alphanumeric-items in working memory-short-term memory (WM-STM), direct and fast access from lexical to semantics, robust semantic word encoding in STM-LTM and fast (non-aware) semantic word retrieval from LTM. On the other hand, the low co-occurrence of some open-bigrams in a word represent rare (low probability) letter combination events, and therefore are more informative concerning the specific word identity than frequent (predictable) occurring open-bigrams letter combination events in a word (Shannon, C. E. (1948), A mathematical theory of communication, Bell Syst. Tech. J. 27, 379-423). In brief, the low co-occurrence of some open-bigrams conveys most information that determines word identity (diagnostic feature).

Grainger and Ziegler explained that both types of constraints are driven by the frequency with which different combinations of letters occur in printed words. On one hand, frequency of occurrence determines the probability with which a given combination of letters belongs to the word being read. Letter combinations that are encountered less often in other words are more diagnostic (an informational feature that renders ‘word identity’) than the identity of the word being processed. In the extreme, a combination of letters that only occurs in a single word in the language, and is therefore a rarely occurring combination of letters event when considering the language as a whole, is highly informative with respect to word identity. On the other hand, the co-occurrence (high frequency of occurrence) enables the formation of higher-order representations (maximal chunking) in order to diminish the amount of information that is processed via data compression. Letter combinations (e.g., open-bigrams and trigrams) that often occur together can be usefully grouped to form higher-level orthographic representations such as multi-letter graphemes (th, ch) and morphemes (ing, er), thus providing a link with pre-existing phonological and morphological representations during reading acquisition (Grainger, J., & Ziegler, J. C. (2011), A dual-route approach to orthographic processing, Frontiers in Psychology, 2(54), 1-13).

The teachings of the present invention claim that open proto-bigram words are a special class/kind of coarse-grained orthographic code that computes (at the same time/in parallel) occurrences of contiguous and non-contiguous letters combinations (conditional probabilities of one or more subsets of open proto-bigram word(s)) within words and in between words (standalone open proto-bigram word) in order to rapidly hone in on a unique informational word identity alongside the corresponding semantic related representations, namely the fast lexical track to semantics (and correlated mental sensory-motor representation-simulation that grounds the specific semantic (word) meaning to the appropriate action).

### Aging and Language

Early research on cognitive aging has pointed out that language processing was spared in old age, in contradistinction to the decline in “fluid” (e.g. reasoning) intellectual abilities, such as remembering new information and in (sensory-motor) retrieving orthographic-phonologic knowledge (Botwinick, J. (1984), Aging and Behavior. New York: Springer). Still, research in this field strongly supports a general asymmetry in the effects of aging on language perception-comprehension versus production (input versus output processes). Older adults exhibit clear deficits in retrieval of phonological and lexical information from speech alongside retrieval of orthographic information from written language, with no corresponding deficits in language perception and comprehension, independent of sensory and new learning deficits. The input side of language includes visual perception of the letters and corresponding speech sounds that make up words and retrieval of semantic and syntactic information about words and sentences. These input-side language processes are commonly referred to as “language comprehension,” and they remain remarkably stable in old age, independent of age-linked declines in sensory abilities (Madden, D. J. (1988), Adult age differences in the effects of sentence context and stimulus degradation during visual word recognition, Psychology and Aging, 3, 167-172) and memory for new information (Light, L., & Burke, D. (1988), Patterns of language and memory in old age, In L. Light, & D. Burke, (Eds.), Language, memory and aging (pp. 244-271). New York: Cambridge University Press; Kemper, S. (1992b), Language and aging, In F. I. M. Craik & T. A. Salthouse (Eds.) The handbook of aging and cognition (pp. 213-270). Hillsdale, N.J.: Lawrence Erlbaum Associates; and Tun, P. A., & Wingfield, A. (1993), Is speech special? Perception and recall of spoken language in complex environments, In J. Cerella, W. Hoyer, J. Rybash, & M. L. Commons (Eds.) Adult information processing: Limits on loss (pp. 425-457) San Diego: Academic Press).

Tasks highlighting language comprehension processes, such as general knowledge and vocabulary scores in tests such as the Wechsler Adult Intelligence Scale, remain stable or improve with aging and provided much of the data for earlier conclusions about age constancy in language perception-comprehension processes. (Botwinick, J. (1984), Aging and Behavior, New York: Springer; Kramer, N. A., & Jarvik, L. F. (1979), Assessment of intellectual changes in the elderly, In A. Raskin & L. F. Jarvik (Eds.), Psychiatric symptoms and cognitive loss in the elderly (pp. 221-271). Washington, D.C.: Hemisphere Publishing; and Verhaeghen, P. (2003), Aging and vocabulary scores: A meta-analysis, Psychology and Aging, 18, 332-339). The output side of language involves retrieval of lexical and phonological information during everyday language production and retrieval of orthographic information such as unit components of words, during every day sensory-motor writing and typing activities. These output-side language processes, commonly termed “language production,” do exhibit age-related dramatic performance declines.

Aging has little effect on the representation of semantic knowledge as revealed, for example, by word associations (Burke, D., & Peters, L. (1986), Word associations in old age: Evidence for consistency in semantic encoding during adulthood, Psychology and Aging, 4, 283-292), script generation (Light, L. L., & Anderson, P. A. (1983), Memory for scripts in young and older adults, Memory and Cognition, 11, 435-444), and the structure of taxonomic categories (Howard, D. V. (1980), Category norms: A comparison of the Battig and Montague (1960) norms with the responses of adults between the ages of 20 and 80, Journal of Gerontology, 35, 225-231; and Mueller, J. H., Kausler, D. H., Faherty, A., & Oliveri, M. (1980), Reaction time as a function of age, anxiety, and typicality, Bulletin of the Psychonomic Society, 16, 473-476). Because comprehension involves mapping language onto existing knowledge structures, age constancy in the nature of these structures is important for maintaining language comprehension in old age. There is no age decrement in semantic processes in comprehension for both off-line and online measures of word comprehension in sentences (Speranza, F., Daneman, M., & Schneider, B. A. (2000) How aging affects reading of words in noisy backgrounds, Psychology and Aging, 15, 253-258). For example, the comprehension of isolated words in the semantic priming paradigm, particularly, the reduction in the time required to identify a target word (TEACHER) when it follows a semantically related word, (STUDENT) rather than a semantically unrelated word (GARDEN); here, perception of STUDENT primes semantically related information, automatically speeding recognition of TEACHER; and such semantic priming effects are at least as large in older adults as they are in young adults (Balota, D. A, Black, S., & Cheney, M. (1992), Automatic and attentional priming in young and older adults: Reevaluation of the two process model, Journal of Experimental Psychology: Human Perception and Performance, 18, 489-502; Burke, D., White, H., & Diaz, D. (1987), Semantic priming in young and older adults: Evidence for age-constancy in automatic and attentional processes, Journal of Experimental Psychology: Human Perception and Performance, 13, 79-88; Myerson, J. Ferraro, F. R., Hale, S., & Lima, S. D. (1992), General slowing in semantic priming and word recognition, Psychology and Aging, 7, 257-270; and Laver, G. D., & Burke, D. M. (1993), Why do semantic priming effects increase in old age? A meta-analysis, Psychology and Aging, 8, 34-43). Similarly, sentence context also primes comprehension of word meanings to an equivalent extent for young and older adults (Burke, D. M., & Yee, P. L. (1984), Semantic priming during sentence processing by young and older adults, Developmental Psychology, 20, 903-910; and Stine, E. A. L., & Wingfield, A. (1994), Older adults can inhibit high-probability competitors in speech recognition, Aging and Cognition, 1, 152-157).

By contrast to the age constancy in comprehending semantic word meaning, extensive experimental research shows age-related declines in retrieving a name (less accurate and slower) corresponding to definitions, pictures or actions (Au, R., Joung, P., Nicholas, M., Obler, L. K., Kass, R. & Albert, M. L. (1995), Naming ability across the adult life span, Aging and Cognition, 2, 300-311; Bowles, N. L., & Poon, L. W. (1985), Aging and retrieval of words in semantic memory, Journal of Gerontology, 40, 71-77; Nicholas, M., Obler, L., Albert, M., & Goodglass, H. (1985), Lexical retrieval in healthy aging, Cortex, 21, 595-606; and Goulet, P., Ska, B., & Kahn, H. J. (1994), Is there a decline in picture naming with advancing age?, Journal of Speech and Hearing Research, 37, 629-644) and in the production of a target word given its definition and initial letter, or given its initial letter and general semantic category (McCrae, R. R., Arenberg, D., & Costa, P. T. (1987), Declines in divergent thinking with age: Cross-sectional, longitudinal, and cross-sequential analyses, Psychology and Aging, 2, 130-137).

Older adults rated word finding failures and tip of the tongue experiences (TOTs) as cognitive problems that are both most severe and most affected by aging (Rabbitt, P., Maylor, E., McInnes, L., Bent, N., & Moore, B. (1995), What goods can self-assessment questionnaires deliver for cognitive gerontology?, Applied Cognitive Psychology, 9, S127-S152; Ryan, E. B., See, S. K., Meneer, W. B., & Trovato, D. (1994), Age-based perceptions of conversational skills among younger and older adults, In M. L. Hummert, J. M. Wiemann, & J. N. Nussbaum (Eds.) Interpersonal communication in older adulthood (pp. 15-39). Thousand Oaks, Calif.: Sage Publications; and Sunderland, A., Watts, K., Baddeley, A. D., & Harris, J. E. (1986), Subjective memory assessment and test performance in the elderly, Journal of Gerontology, 41, 376-384). Older adults rated retrieval failures for proper names as especially common (Cohen, G., & Faulkner, D. (1984), Memory in old age: “good in parts” New Scientist, 11, 49-51; Martin, M. (1986); Ageing and patterns of change in everyday memory and cognition, Human Learning, 5, 63-74; and Ryan, E. B. (1992), Beliefs about memory changes across the adult life span, Journal of Gerontology: Psychological Sciences, 47, P41-P46) and the most annoying, embarrassing and irritating of their memory problems (Lovelace, E. A., & Twohig, P. T. (1990), Healthy older adults' perceptions of their memory functioning and use of mnemonics, Bulletin of the Psychonomic Society, 28, 115-118). They also produce more ambiguous references and pronouns in their speech, apparently because of an inability to retrieve the appropriate nouns (Cooper, P. V. (1990), Discourse production and normal aging: Performance on oral picture description tasks, Journal of Gerontology: Psychological Sciences, 45, P210-214; and Heller, R. B., & Dobbs, A. R. (1993), Age differences in word finding in discourse and nondiscourse situations, Psychology and Aging, 8, 443-450). Speech disfluencies, such as filled pauses and hesitations, increase with age and may likewise reflect word retrieval difficulties (Cooper, P. V. (1990), Discourse production and normal aging: Performance on oral picture description tasks, Journal of Gerontology: Psychological Sciences, 45, P210-214; and Kemper, S. (1992a), Adults' sentence fragments: Who, what, when, where, and why, Communication Research, 19, 444-458).

Further, TOT states increase with aging, accounting for one of the most dramatic instances of word finding difficulty in which a person is unable to produce a word although absolutely certain that they know it. Both naturally occurring TOTs (Burke, D. M., MacKay, D. G., Worthley, J. S., & Wade, E. (1991), On the tip of the tongue: What causes word finding failures in young and older adults, Journal of Memory and Language, 30, 542-579) and experimentally induced TOTs increase with aging (Burke, D. M., MacKay, D. G., Worthley, J. S., & Wade, E. (1991), On the tip of the tongue: What causes word finding failures in young and older adults, Journal of Memory and Language, 30, 542-579; Brown, A. S., & Nix, L. A. (1996), Age-related changes in the tip-of-the-tongue experience, American Journal of Psychology, 109, 79-91; James, L. E., & Burke, D. M. (2000), Phonological priming effects on word retrieval and tip-of-the-tongue experiences in young and older adults, Journal of Experimental Psychology: Learning. Memory, and Cognition, 26, 1378-1391; Maylor, E. A. (1990b), Recognizing and naming faces: Aging, memory retrieval and the tip of the tongue state, Journal of Gerontology: Psychological Sciences, 45, P215-P225; and Rastle, K. G., & Burke, D. M. (1996), Priming the tip of the tongue: Effects of prior processing on word retrieval in young and older adults, Journal of Memory and Language, 35, 586-605).

Still, word retrieval failures in young and especially older adults appear to reflect declines in access to phonological representations. Evidence for age-linked declines in language production has come almost exclusively from studies of word retrieval. MacKay and Abrams reported that older adults made certain types of spelling errors more frequently than young adults in written production, a sub-lexical retrieval deficit involving orthographic units (MacKay, D. G., Abrams, L., & Pedroza, M. J. (1999), Aging on the input versus output side: Theoretical implications of age-linked asymmetries between detecting versus retrieving orthographic information, Psychology and Aging, 14, 3-17). This decline occurred despite age equivalence in the ability to detect spelling errors and despite the higher vocabulary and education levels of older adults. The phonological/orthographic knowledge retrieval problem in old age is not due to deficits in formulating the idea to be expressed, but rather it appears to reflect an inability to map a well-defined idea or lexical concept onto its phonological and orthographic unit forms. Thus, unlike semantic comprehension of word meaning, which seems to be well-preserved in old age, sensory-motor retrieval of phonological and orthographic representations declines with aging.

### Language Production Deficits in Normal Aging and Open-Bigrams and Open Proto-Bigrams Priming

The teachings of the present invention are in agreement with some of the mechanisms and predictions of the transmission deficit hypothesis (TDH) computational model (Burke, D. M., Mackay, D. G., & James L. E. (2000), Theoretical approaches to language and aging, In T. J. Perfect & E. A. Maylor (Eds.), Models of cognitive aging (pp. 204-237). Oxford, England: Oxford University Press; and MacKay, D. G., & Burke, D. M. (1990), Cognition and aging: A theory of new learning and the use of old connections, In T. M. Hess (Ed.), Aging and cognition: Knowledge organization and utilization (pp. 213-263). Amsterdam: North Holland). Briefly, under the TDH, verbal information is represented in a network of interconnected units or nodes organized into a semantic system representing lexical and propositional meaning and a phonological system representing sounds. In addition to these nodes, there is a system of orthographic nodes with direct links to lexical nodes and also lateral links to corresponding phonological nodes (necessary for the production of novel words and pseudowords). In the TDH, language word comprehension (input) versus word production (output) differences arise from an asymmetrical structure of top-down versus bottom-up priming connections to the respective nodes.

In general, the present invention stipulates that normal aging weakens the priming effects of open-bigrams in words, particularly open proto-bigrams inside words and in between words in a sentence or fluent speech. This weakening priming effect of open proto-bigrams negatively impacts the direct lexical to semantics access route for automatically knowing the most common words in a language, and in particular, causes slow, non-accurate (spelling mistakes) recognition and retrieval of the orthographic code via writing and typing as well as slow, non-accurate (errors) or TOT of phonological and lexical information concerning particular types of naming word retrievals from speech. It is worth noticing that with aging, this priming weakening effect of open-bigrams and open proto-bigrams greatly diminishes the benefits of possessing a language with a high lexical-phonological information and lexical orthographic code representation redundancy. Therefore, it is to be expected that older individuals will increase content production errors in written-spoken messages, making phonological and lexical information via speech naming retrieval, and/or lexical orthographic production via writing, less resistant to noise. In other words, the early language advantage resting upon a flexible orthographic code and a flexible lexical-phonological informational encoding of speech becomes a disadvantage with aging since the orthographic or lexical-phonological code will become too flexible and prompt too many production errors.

The teachings of the present invention point out that language production deficits, particularly negatively affecting open-bigrams and open proto-bigrams when aging normally, promote an inefficient and noisy sensory-motor grounding of cognitive (top-down) fluent reasoning/intellectual abilities reflected in slow, non-accurate or wrong substitutions of ‘naming meaning’ in specific domains (e.g., names of people, places, dates, definitions, etc.) The teachings of the present invention further hypothesize that in a mild to severe progression Alzheimer's or dementia individual, language production deficits worsen and expand to also embrace wrong or non-sensory-motor grounding of cognitive (top-down) fluent reasoning/intellectual abilities thus causing a partial or complete informational disconnect/paralysis between object naming retrieval and the respective action-use domain of the retrieved object.

### A Novel Neuro-Performance Non-Pharmacological Alphabetic Language Based Technology

Without limiting the scope of the present invention, the teachings of the present invention disclose a non-pharmacological technology aiming to promote novel exercising of alphanumeric symbolic information. The present invention aims for a subject to problem solve and perform a broad spectrum of relationships among alphanumeric characters. For that purpose, direct and inverse alphabetical strings are herein presented comprising a constrained serial positioning order among the letter characters as well as randomized alphabetical strings comprising a non-constrained alphabetical serial positioning order among the letter characters. The herein presented novel exercises involve visual and/or auditory searching, identifying/recognizing, sensory-motor selecting and organizing of one or more open-bigrams and/or open proto-bigrams in order to promote fluid reasoning ability in a subject manifested in an effortless, fast and efficient problem solving of particular letter characters relationships in direct-inverse alphabetical and/or randomized alphabetical sequences. Still, the herein non-pharmacological technology, consist of novel exercising of open-bigrams and open proto-bigrams to promote: a) a strong grounding of lexical-phonological cognitive information in spoken language and of lexical orthographic unit components in writing language, b) a language neuro-prophylactic shielding against language production processing deficits in normal aging population, c) a language neuro-prophylactic shielding against language production processing deficits in MCI people, and d) a language neuro-prophylactic shielding against language production processing deficits capable of slowing down (or reversing) early mild neural degeneration cognitive adversities in Alzheimer's and dementia individuals.

Orthographic Sequential Encoded Regulated by Inputs to Oscillations within Letter Units (‘SERIOL’) Processing Model:

According to the SERIOL processing model, orthographic processing occurs at two levels-the neuronal level, and the abstract level. At the neuronal level, orthographic processing occurs progressively beginning from retinal coding (e.g., string position of letters within a string), followed by feature coding (e.g., lines, angles, curves), and finally letter coding (coding for letter nodes according to temporal neuronal firing.) At the abstract level, the coding hierarchy is (open) bigram coding (i.e., sequential ordered pairs of letters—correlated to neuronal firings according to letter nodes) followed by word coding (coding by: context units—words represented by visual factors—serial proximity of constituent letters). ((Whitney, C. (2001a), How the brain encodes the order of letters in a printed word: The SERIOL model and selective literature review, Psychonomic Bulletin and Review, 8, 221-243).

Some Statistical Aspects of Sequential Order of Letters and Letter Strings:

In the English language, in a college graduate vocabulary of about 20,000 letter strings (words), there are about only 50-60 words which obey a direct A-Z or indirect Z-A sequential incomplete alphabetical different letters serial order (e.g., direct A-Z “below” and inverse Z-A “the”). More so, about 40% of everything said, read or written in the English language consists of frequent repetitions of open proto-bigrams (e.g., is, no, if, or etc.) words in between words in written sentences or uttered words in between uttered words in a conversation. In the English language, letter trigrams frequent repetitions (e.g. “the”, ‘can’, ‘his’, ‘her’, ‘its’, etc.) constitute more than 10% of everything said, read or written.

### Methods

The definition given to the terms below is in the context of their meaning when used in the body of this application and in its claims.

The below definitions, even if explicitly referring to letters sequences, should be considered to extend into a more general form of these definitions to include numerical and alphanumerical sequences, based on predefined complete numerical and alphanumerical set arrays and a formulated meaning for pairs of non-equal and non-consecutive numbers in the predefined set array, as well as for pairs of alphanumeric characters of the predefined set array.

A “series” is defined as an orderly sequence of terms

“Serial terms” are defined as the individual components of a series.

A “serial order” is defined as a sequence of terms characterized by: (a) the relative ordinal spatial position of each term and the relative ordinal spatial positions of those terms following and/or preceding it; (b) its sequential structure: an “indefinite serial order,” is defined as a serial order where no first neither last term are predefined; an “open serial order.” is defined as a serial order where only the first term is predefined; a “closed serial order,” is defined as a serial order where only the first and last terms are predefined; and (c) its number of terms, as only predefined in ‘a closed serial order’.

“Terms” are represented by one or more symbols or letters, or numbers or alphanumeric symbols.

“Arrays” are defined as the indefinite serial order of terms. By default, the total number and kind of terms are undefined.

“Terms arrays” are defined as open serial orders of terms. By default, the total number and kind of terms are undefined.

“Set arrays” are defined as closed serial orders of terms, wherein each term is intrinsically a different member of the set and where the kinds of terms, if not specified in advance, are undefined. If, by default, the total number of terms is not predefined by the method(s) herein, the total number of terms is undefined.

“Letter set arrays” are defined as closed serial orders of letters, wherein same letters may be repeated.

An “alphabetic set array” is a closed serial order of letters, wherein all the letters are predefined to be different (not repeated). Still, each letter member of an alphabetic set array has a predefined different ordinal position in the alphabetic set array. An alphabetic set array is herein considered to be a Complete Non-Randomized alphabetical letters sequence. Letter symbol members are herein only graphically represented with capital letters. For single letter symbol members, the following complete 3 direct and 3 inverse alphabetic set arrays are herein defined:

Direct alphabetic set array: A, B, C, D, E, F, G, H, I, J, K, L, M, N, O, P, Q, R, S, T, U, V, W, X, Y, Z.

Inverse alphabetic set array: Z, Y, X, W, V, U, T, S, R, Q, P, O, N, M, L, K, J, I, H, G, F, E, D, C, B, A.

Direct type alphabetic set array: A, Z, B, Y, C, X, D, W, E, V, F, U, G, T, H, S, I, R, J, Q, K, P, L, O, M, N.

Inverse type alphabetic set array: Z, A, Y, B, X, C, W, D, V, E, U, F, T, G, S, H, R, I, Q, J, P, K, O, L, N, M.

Central type alphabetic set array: A, N, B, O, C, P, D, Q, E, R, F, S, G, T, H, U, I, V, J, W, K, X, L, Y, M, Z.

Inverse central type alphabetic set array: N, A, O, B, P, C, Q, D, R, E, S, F, T, G, U, H, V, I, W, J, X, K, Y, L, Z, M.

An “open bigram,” if not specified otherwise, is herein defined as a closed serial order formed by any two contiguous or non-contiguous letters of the above alphabetic set arrays. Under the provisions set forth above, an “open bigram” may also refer to pairs of numerical or alpha-numerical symbols.

For Alphabetic Set Arrays where the Members are Defined as Open Bigrams, the Following 3 Direct and 3 Inverse Alphabetic Open Bigrams Set Arrays are Herein Defined

Direct alphabetic open bigram set array: AB, CD, EF, GH, IJ, KL, MN, OP, QR, ST, UV, WX, YZ.

Inverse alphabetic open bigram set array: ZY, XW, VU, TS, RQ, PO, NM, LK, JI, HG, FE, DC, BA.

Direct alphabetic type open bigram set array: AZ, BY, CX, DW, EV, FU, GT, HS, IR, JQ, KP, LO, MN.

Inverse alphabetic type open bigram set array: ZA, YB, XC, WD, VE, UF, TG, SH, RI, QJ, PK, OL, NM.

Central alphabetic type open bigram set array: AN, BO, CP, DQ, ER, FS, GT, HU, IV, JW, KX, LY, MZ.

Inverse alphabetic central type open bigram set array: NA, OB, PC, QD, RE, SF, TG, UH, VI, WJ, XK, YL, ZM.

An “open bigram term” is a lexical orthographic unit characterized by a pair of letters (n-gram) depicting a minimal sequential order consisting of two letters. The open bigram class to which an open bigram term belongs may or may not convey an automatic direct access to semantic meaning in an alphabetic language to a reader.

An “open bigram term sequence” is a letters symbol sequence, where two letter symbols are presented as letter pairs representing a term in the sequence, instead of an individual letter symbol representing a term in the sequence.

There are 4 classes of Open Bigram terms, there being a total of 676 different open bigram terms in the English alphabetical language

Class I—Within the context of the present subject matter, Class I always refers to “open proto-bigram terms”. Specifically, there are 24 open proto-bigram terms in the English alphabetical language.

Class II—Within the context of the present subject matter, Class II consists of open bigram terms entailed in alphabetic open bigram set arrays (6 of these alphabetic open bigram set arrays are herein defined for the English alphabetical language). Specifically, Class II comprises a total of 78 different open bigram terms wherein 2 open bigram terms are also open bigram terms members of Class I.

Class III—Within the context of the present subject matter, Class III entails the vast majority of open bigram terms in the English alphabetical language except for all open bigram terms members of Classes I, II, and IV. Specifically, Class III comprises a total of 550 open bigram terms.

Class IV—Within the context of the present subject matter, Class IV consists of open bigram terms entailing repeated single letters symbols. For the English alphabetical language, Class IV comprises a total of 26 open bigram terms.

An alphabetic “open proto-bigram term” (see Class I above) is defined as a lexical orthographic unit characterized by a pair of letters (n-gram) depicting the smallest sequential order of contiguous and non-contiguous different letters that convey an automatic direct access to semantic meaning in an alphabetical language (e.g., English alphabetical language: an, to, so etc.).

An “open proto-bigram sequence type” is herein defined as a complete alphabetic open proto-bigram sequence characterized by the pairs of letters comprising each open proto-bigram term in a way that the serial distribution of such open proto-bigram terms establishes a sequence of open proto-bigram terms type that follows a direct or an inverse alphabetic set array order. In summary, there are two complete alphabetic open proto-bigram sequence types.

Types of Open Proto-Bigram Sequences:

Direct type open proto-bigram sequence: AM, AN, AS, AT, BE, BY, DO, GO, IN, IS, IT, MY, NO, OR

Inverse type open proto-bigram sequence: WE, US, UP, TO, SO, ON, OF, ME, IF, HE.

“Complete alphabetic open proto-bigram sequence groups” within the context of the present subject matter, Class I open-proto bigram terms, are further grouped in three sequence groups:

Open Proto-Bigram Sequence Groups:

Left Group: AM, BE, HE, IF, ME

Central Group: AN, AS, AT, BY, DO, GO, IN, IS, IT, MY, OF, WE

Right Group: NO, ON, OR, SO, TO, UP, US

The term “collective critical space” is defined as the alphabetic space in between two non-contiguous ordinal positions of a direct or inverse alphabetic set array. A “collective critical space” further corresponds to any two non-contiguous letters which form an open proto-bigram term. The postulation of a “collective critical space” is herein contingent to any pair of non-contiguous letter symbols in a direct or inverse alphabetic set array, where their orthographic form directly and automatically conveys a semantic meaning to the subject.

The term “virtual sequential state” is herein defined as an implicit incomplete alphabetic sequence made-up of the letters corresponding to the ordinal positions entailed in a “collective critical space”. There is at least one implicit incomplete alphabetic sequence entailed per each open proto-bigram term. These implicit incomplete alphabetic sequences are herein conceptualized to exist in a virtual perceptual-cognitive mental state of the subject. Every time that this virtual perceptual-cognitive mental state is grounded by means of a programmed goal oriented sensory-motor activity in the subject, his/her reasoning and mental cognitive ability is enhanced.

From the above definitions, it follows that a letters sequence, which at least entails two non-contiguous letters forming an open proto-bigram term, will possess a “collective critical spatial perceptual related attribute” as a direct consequence of the implicit perceptual condition of the at least one incomplete alphabetic sequence arising from the “virtual sequential state” in correspondence with the open proto-bigram term. This virtual/abstract serial state becomes concrete every time a subject is required to reason and perform goal oriented sensory motor action to problem solve a particular kind of serial order involving relationships among alphabetic symbols in a sequence of symbols. One way of promoting this novel reasoning ability is achieved through a predefined goal oriented sensory motor activity of the subject by performing a data “compression” of a selected letters sequence or by performing a data “expansion” of a selected letters sequence in accordance with the definitions of the terms given below.

Moreover, as already indicated above for a general form of these definitions, for a predefined Complete Numerical Set Array and a predefined Complete Alphanumeric Set Array, the “collective critical space”, “virtual sequential state” and “collective critical spatial perceptual related attribute” for alphabetic series can also be extended to include numerical and alphanumerical series.

An “ordinal position” is defined as the relative position of a term in a series, in relation to the first term of this series, which will have an ordinal position defined by the first integer number (#1), and each of the following terms in the sequence with the following integer numbers (#2, #3, #4, . . . ). Therefore, the 26 different letter terms of the English alphabet will have 26 different ordinal positions which, in the case of the direct alphabetic set array (see above), ordinal position #1 will correspond to the letter “A”, and ordinal position #26 will correspond to the letter “Z”.

An “alphabetic letter sequence,” unless otherwise specified, is herein one or more complete alphabetic letter sequences from the group comprising: Direct alphabetic set array, Inverse alphabetic set array, Direct open bigram set array, Inverse open bigram set array, Direct open proto-bigram sequence, and Inverse open proto-bigram sequence.

The term “incomplete” serial order refers herein only in relation to a serial order which has been previously defined as “complete.”

As used herein, the term “relative incompleteness” is used in relation to any previously selected serial order which, for the sake of the intended task herein required performing by a subject, the said selected serial order could be considered to be complete.

As used herein, the term “absolute incompleteness” is used only in relation to alphabetic set arrays, because they are defined as complete closed serial orders of terms (see above). For example, in relation to an alphabetic set array, incompleteness is absolute, involving at the same time: number of missing letters, type of missing letters and ordinal positions of missing letters.

A “non-alphabetic letter sequence” is defined as any letter series that does not follow the sequence and/or ordinal positions of letters in any of the alphabetic set arrays.

A “symbol” is defined as a mental abstract graphical sign/representation, which includes letters and numbers.

A “letter term” is defined as a mental abstract graphical sign/representation, which is generally, characterized by not representing a concrete: thing/item/form/shape in the physical world. Different languages may use the same graphical sign/representation depicting a particular letter term, which it is also phonologically uttered with the same sound (like “s”).

A “letter symbol” is defined as a graphical sign/representation depicting in a language a letter term with a specific phonological uttered sound. In the same language, different graphical sign/representation depicting a particular letter term, are phonologically uttered with the same sound(s) (like “a” and “A”).

An “attribute” of a term (alphanumeric symbol, letter, or number) is defined as a spatial distinctive related perceptual feature and/or time distinctive related perceptual feature. An attribute of a term can also be understood as a related on-line perceptual representation carried through a mental simulation that effects the off-line conception of what it's been perceived. (Louise Connell, Dermot Lynott. Principles of Representation: Why You Can't Represent the Same Concept Twice. Topics in Cognitive Science (2014) 1-17)

A “spatial related perceptual attribute” is defined as a characteristically spatial related perceptual feature of a term, which can be discriminated by sensorial perception. There are two kinds of spatial related perceptual attributes.

An “individual spatial related attribute” is defined as a spatial related perceptual attribute that pertains to a particular term. Individual spatial related perceptual attributes include, e.g., symbol case; symbol size; symbol font; symbol boldness; symbol tilted angle in relation to a horizontal line; symbol vertical line of symmetry; symbol horizontal line of symmetry; symbol vertical and horizontal lines of symmetry; symbol infinite lines of symmetry; symbol no line of symmetry; and symbol reflection (mirror) symmetry.

A “collective spatial related attribute” is defined as a spatial related perceptual attribute that pertains to the relative location of a particular term in relation to the other terms in a letter set array, an alphabetic set array, or an alphabetic letter symbol sequence. Collective spatial related attributes (e.g. in a set array) include a symbol ordinal position, the physical space occupied by a symbol font, the distance between the physical spaces occupied by the fonts of two consecutive symbols/terms when represented in orthographical form, and left or right relative edge position of a term/symbol font in a set array. Even if triggering a sensorial perceptual relation with the reasoning subject, a “collective spatial related perceptual attribute” is not related to the semantic meaning of the one or more letter symbols possessing this spatial perceptual related attribute. In contrast, the “collective critical space” is contingent on the generation of a semantic meaning in a subject by the pair of non-contiguous letter symbols implicitly entailing this collective critical space.

A “time related perceptual attribute” is defined as a characteristically temporal related perceptual feature of a term (symbol, letter or number), which can be discriminated by sensorial perception such as: a) any color of the RGB full color range of the symbols term; b) frequency range for the intermittent display of a symbol, of a letter or of a number, from a very low frequency rate, up till a high frequency (flickering) rate. Frequency is quantified as: 1/t, where t is in the order of seconds of time; c) particular sound frequencies by which a letter or a number is recognized by the auditory perception of a subject; and d) any herein particular constant motion represented by a constant velocity/constant speed (V) at which symbols, letters, and/or numbers move across the visual or auditory field of a subject. In the case of Doppler auditory field effect, where sounds representing the names of alphanumeric symbols, letters, and/or numbers are approximating or moving away in relation to a predefined point in the perceptual space of a subject, constant motion is herein represented by the speed of sound. By default, this constant motion of symbols, letters, and/or numbers is herein considered to take place along a horizontal axis, in a spatial direction to be predefined. If the visual perception of constant motion is implemented on a computer screen, the value of V to be assigned is given in pixels per second at a predefined screen resolution.

It has been empirically observed that when the first and last letter symbols of a word are maintained, the reader's semantic meaning of the word may not be altered or lost by removing one or more letters in between them. This orthographic transformation is named data “compression”. Consistent with this empirical observation, the notion of data “compression” is herein extended into the following definitions:

If a “symbols sequence is subject to compression” which is characterized by the removal of one or more contiguous symbols located in between two predefined symbols in the sequence of symbols, the two predefined symbols may, at the end of the compression process, become contiguous symbols in the symbols sequence, or remain non-contiguous if the omission or removal of symbols is done on non-contiguous symbols located between the two predefined symbols in the sequence.

Due to the intrinsic semantic meaning carried by an open proto-bigram term, when the two predefined symbols in a sequence of symbols are the two letters symbols forming an open proto-bigram term, the compression of a letter sequence is considered to take place at two sequential levels, “local” and “non-local”, and the non-local sequential level comprises an “extraordinary sequential compression case.”

A “local open proto-bigram term compression” is characterized by the omission or removal of one or two contiguous letters in a sequence of letters lying in between the two letters that form/assemble an open proto-bigram term, by which the two letters of the open proto-bigram term become contiguous letters in the letters sequence.

A “non-local open proto-bigram compression” is characterized by the omission or removal of more than two contiguous letters in a sequence of letters, lying in between two letters at any ordinal serial position in the sequence that form an open proto-bigram term, by which the two letters of the open proto-bigram term become contiguous letters in the letters sequence.

An “extraordinary non-local open proto-bigram compression” is a particular case of a non-local open proto-bigram term compression, which occurs in a letters sequence comprising N letters when the first and last letters in the letters sequence are the two selected letters forming/assembling an open proto-bigram term, and the N−2 letters lying in between are omitted or removed, by which the remaining two letters forming/assembling the open proto-bigram term become contiguous letters.

An “alphabetic expansion” of an open proto-bigram term is defined as the orthographic separation of its two (alphabetical non-contiguous letters) letters by the serial sensory motor insertion of the corresponding incomplete alphabetic sequence directly related to its collective critical space according to predefined timings. This sensory motor ‘alphabetic expansion’ will explicitly make the particular related virtual sequential state entailed in the collective critical space of this open proto-bigram term concrete.

“Orthographic letters contiguity” is defined as the contiguity of letters symbols in a written form by which words are represented in most written alphabetical languages.

For “alphabetic contiguity,” a visual recognition facilitation effect occurs for a pair of letters forming any open bigram term, even when 1 or 2 letters in orthographic contiguity lying in between these two (now) edge letters form the open bigram term. It has been empirically confirmed that up to 2 letters located contiguously in between the open bigram term do not interfere with the visual identity and resulting perceptual recognition process of the pair of letters making-up the open bigram term. In other words, the visual perceptual identity of an open bigram term (letter pair) remains intact even in the case of up two letters held in between these two edge letters forming the open bigram term.

However, in the particular case where open bigram terms orthographically directly convey/communicate a semantic meaning in a language (e.g., open proto-bigrams), it is herein considered that the visual perceptual identity of open proto-bigram terms remains intact even when more than 2 letters are held in between the now edge letters forming the open proto-bigram term. This particular visual perceptual recognition effect is considered as an expression of: 1) a Local Alphabetic Contiguity effect—empirically manifested when up to two letters are held in between (LAC) for open bigrams and open proto-bigrams terms and 2) a Non-Local Alphabetic Contiguity (NLAC) effect—empirically manifested when more than two letters are held in between, an effect which only take place in open proto-bigrams terms.

Both LAC and NLAC are part of a herein novel methodology aiming to advance a flexible orthographic decoding and processing view concerning sensory motor grounding of perceptual-cognitive alphabetical, numerical, and alphanumeric information/knowledge. LAC correlates to the already known priming transposition of letters phenomena, and NLAC is a new proposition concerning the visual perceptual recognition property particularly possessed only by open proto-bigrams terms which is enhanced by the performance of the herein proposed methods. For the 24 open proto-bigram terms found in the English language alphabet, 7 open proto-bigram terms are of a default LAC consisting of 0 to 2 in between ordinal positions of letters in the alphabetic direct-inverse set array because of their unique respective intrinsic serial order position in the alphabet. The remaining 17 open proto-bigrams terms are of a default NLAC consisting of an average of more than 10 letters held in between ordinal positions in the alphabetic direct-inverse set array.

The present subject matter considers the phenomena of ‘alphabetic contiguity’ being a particular top-down cognitive-perceptual mechanism that effortlessly and autonomously causes arousal inhibition in the visual perception process for detecting, processing, and encoding the N letters held in between the 2 edge letters forming an open proto-bigram term, thus resulting in maximal data compression of the letters sequence. As a consequence of the alphabetic contiguity orthographic phenomena, the space held in between any 2 non-contiguous letters forming an open proto-bigram term in the alphabet is of a critical perceptual related nature, herein designated as a ‘Collective Critical Space Perceptual Related Attribute’ (CCSPRA) of the open proto-bigram term, wherein the letters sequence which is attentionally ignored-inhibited, should be conceptualized as if existing in a virtual mental kind of state. This virtual mental kind of state will remain effective even if the 2 letters making-up the open proto-bigram term will be in orthographic contiguity (maximal serial data compression).

When the 2 letters forming an open proto-bigram term hold in between a number of N letters and when the serial ordinal position of these two letters are the serial position of the edge letters of a letters sequence (meaning that there are no additional letters on either side of these two edge letters), the alphabetic contiguity property will only pertain to these 2 edge letters forming the open proto-bigram term. In brief, this particular case discloses the strongest manifestation of the alphabetic contiguity property, where one of the letters making up an open proto-bigram term is the head and the other letter is the tail of a letters sequence. This particular case is herein designated as Extraordinary NLAC.

An “arrangement of terms” (symbols, letters and/or numbers) is defined as one of two classes of term arrangements, i.e., an arrangement of terms along a line, or an arrangement of terms in a matrix form. In an “arrangement along a line,” terms will be arranged along a horizontal line by default. If for example, the arrangement of terms is meant to be along a vertical or diagonal or curvilinear line, it will be indicated. In an “arrangement in a matrix form,” terms are arranged along a number of parallel horizontal lines (like letters arrangement in a text book format), displayed in a two dimensional format.

The terms “generation of terms,” “number of terms generated” (symbols, letters and/or numbers) is defined as terms generally generated by two kinds of term generation methods one method wherein the number of terms is generated in a predefined quantity; and another method wherein the number of terms is generated by a quasi-random method.

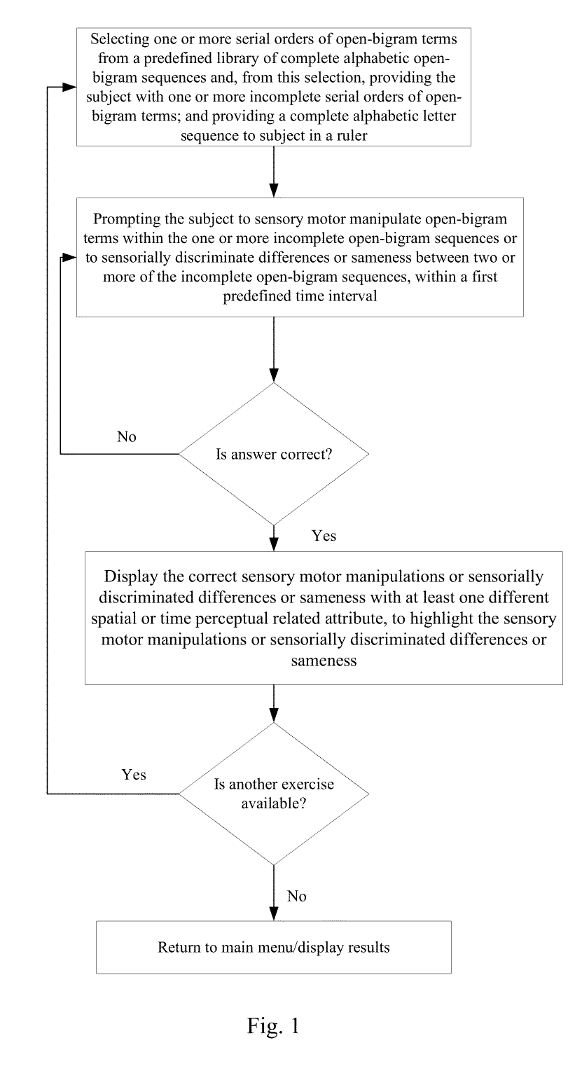

FIG. 1 is a flow chart setting forth the broad concepts covered by the specific non-limiting exercises put forth in the Examples below.

As can be seen in FIG. 1, the method of promoting fluid intelligence abilities in the subject comprises selecting at least one serial order of open-bigram terms from a predefined library of complete open-bigrams sequences and providing the subject with one or more incomplete serial orders of open-bigram terms obtained from the previously selected complete serial order of open-bigram terms. The subject is then prompted, within an exercise, to manipulate open-bigram terms within one or more incomplete open-bigram sequences, or to discriminate differences or sameness between two or more of the incomplete serial orders within a first predefined time interval. After manipulating the open-bigram terms or discriminating differences or sameness between the two or more incomplete open-bigram sequences, an evaluation is performed to determine whether the subject correctly manipulated the open-bigram terms or correctly discriminated differences or sameness between the two or more incomplete open-bigram sequences.

If the subject made an incorrect manipulation or discrimination, then the exercise is started again and the subject is prompted, within the exercise, to again manipulate open-bigram terms within the one or more incomplete open-bigram sequences or to discriminate differences or sameness between two or more incomplete open-bigram sequences, within the first predefined time interval. If, however, the subject correctly manipulated the open-bigram terms or correctly discriminated differences or sameness between the two or more of the incomplete open-bigram sequences, then the correct manipulations as well as correct discrimination of differences or sameness, are displayed with at least one different attribute to highlight or remark the manipulation and the discriminated difference or sameness.

The above steps in the method are repeated for a predetermined number of iterations separated by second predefined time intervals, and upon completion of the predetermined number of iterations, the subject is provided with the results of each iteration. The predetermined number of iterations can be any number needed to establish that a proficient reasoning performance concerning the particular task at hand is being promoted within the subject. Non-limiting examples of number of iterations include 1, 2, 3, 4, 5, 6, and 7.

It is important to point out/consider that, in the above method of promoting reasoning abilities and in the following exercises and examples implementing the method, the subject is performing the discrimination of open bigrams or open proto-bigram terms in an array/series of open bigrams and/or open proto-bigram sequences without invoking explicit conscious awareness concerning underlying implicit governing rules or abstract concepts/interrelationships, characterized by relations or correlations or cross-correlations among the searched, discriminated and sensory motor manipulated open bigrams and open proto-bigrams terms by the subject. In other words, the subject is performing the search and discrimination without overtly thinking or strategizing about the necessary actions to effectively accomplish the sensory motor manipulation of the open bigrams and open proto-bigram terms.

As mentioned in connection with the general form of the above definitions, the herein presented suite of exercises can make use of not only letters but also numbers and alphanumeric symbols relationships. These relationships include correlations and cross-correlations among open bigrams and/or open proto-bigram terms such that the mental ability of the exercising subject is able to promote novel reasoning strategies that improve fluid intelligence abilities. The improved fluid intelligence abilities will be manifested in at least effective and rapid mental simulation, novel problem solving, drawing inductive-deductive inferences, pattern and irregularities recognition, identifying relations, correlations and cross-correlations among sequential orders of symbols comprehending implications, extrapolating, transforming information and abstract concept thinking.

As mentioned earlier, it is also important to consider that the methods described herein are not limited to only alphabetic symbols. It is also contemplated that the methods of the present subject can involve numeric serial orders and/or alpha-numeric serial orders to be used within the exercises. In other words, while the specific examples set forth employ serial orders of letter symbols, alphabetic open bigram terms and alphabetic open proto-bigram terms, it is contemplated that serial orders comprising numbers and/or alpha-numeric symbols can be used.

A library of open-bigram sequences comprises those obtained with letter symbols from alphabetic set arrays, which may include open-bigram sequences derived from other set arrays (of numerical or alphanumerical symbols). Alphabetic set arrays are characterized by comprising a predefined number of different letter terms, each letter term having a predefined unique ordinal position in the closed set array, and none of said different letter terms are repeated within this predefined unique serial order of letter terms. A non-limiting example of a unique letter set array is the English alphabet, in which there are 13 predefined different open-bigram terms where each open-bigram term has a predefined consecutive ordinal position of a unique closed serial order among 13 different members of an open-bigram set array only comprising 13 members.

In one aspect of the present subject matter, a predefined library of complete alphabetic open-bigrams sequences is herein considered. The English alphabet is herein considered as a direct alphabetic set array, from which only one unique serial order of open-bigram terms is obtained. There are at least five other different unique alphabetic set arrays herein considered. As mentioned above, the English alphabet is a particular alphabetic set array herein denominated as a direct alphabetic set array. There are other five different alphabetic set arrays contemplated from which another five unique alphabetic open-bigram set arrays are obtained, denominated herein as: inverse alphabetic open-bigram set array, direct type of alphabetic open-bigram set array, inverse type of alphabetic open-bigram set array, central type of alphabetic open-bigram set array, and inverse central type alphabetic open-bigram set array. It is understood that the above predefined library of open-bigram terms sequences may contain fewer open-bigram terms sequences than those listed above or that it may comprise more different open-bigram sequences.

In an aspect of the present methods, the at least one unique serial order comprises a sequence of open-bigram terms. In this aspect of the present subject matter, the predefined library of open-bigram sequences may comprise the following sequential orders of open-bigrams terms, where each open-bigram term is a different member of a set array having a predefined unique ordinal position within the set: direct open-bigram set array, inverse open-bigram set array, direct type open-bigram set array, inverse type open-bigram set array, central type open-bigram set array, and inverse central type open-bigram set array. It is understood that the above predefined library of open-bigram sequences may contain additional or fewer open-bigram sequences than those listed above.

In each of the non-limiting Examples below, the subject is presented with various exercises and prompted to make selections based upon the particular features of the exercises. It is contemplated that, within the non-limiting Examples 1-6, the choice method presented to the subject could be any one of three particular non-limiting choice methods: multiple choice, force choice, and/or go-no-go choice.

When the subject is provided with multiple choices when performing the exercise, the subject is presented multiple choices as to what the possible answer is. The subject must discern the correct answer/selection and select the correct answer from the given multiple choices.

When the force choice method is employed within the exercises, the subject is presented with two alternatives for the correct answer and, as is implicit in the name, the subject is forced to make that choice. In other words, the subject is forced to select the correct answer from the two possible answers presented to the subject.

Likewise, a choice method presented to the subject is a go-no-go choice method. In this method, the subject is prompted to answer every time the subject is exposed to the possible correct answer. In a non-limiting example, the subject may be requested to click or not on a particular button each time a certain open-bigram term is shown to the subject. Alternatively, the subject may be requested to click on one of two different buttons each time another certain open-bigram term is displayed. Thus, the subject clicks on one of the two buttons when his/her reasoning indicates that the correct open-bigram term appears and does not click on the other button if his/her reasoning indicates that the correct open-bigram term is not there.

In another aspect of the each of the non-limiting examples described herein, the change in attributes is done according to predefined correlations between space and time related attributes and the ordinal position of those open-bigram terms. As a non-limiting example, for the particular case of a complete direct alphabetic set array of the English language falling inside the perceptual visual field of the subject, the first ordinal position (occupied by the letter “A”), will generally appear towards the left side of his/her fields of vision, whereas the last ordinal position (occupied by the letter “Z”) will appear towards his/her right visual field of vision. Further, if the ordinal position of the open-bigram term for which an attribute will be changed falls in the left field of vision, the change in attribute may be different than if the ordinal position of the open-bigram term for which the attribute will be changed falls in the right field of vision.

In this non-limiting example, if the attribute to be changed is the color of the open-bigram term, and if the ordinal position of the open-bigram term for which the attribute will be changed falls in the left field of vision, then the color will be changed to a first different color, while if the ordinal position of the open-bigram term falls in the right field of vision, then the color will be changed to a second color different from the first color. Likewise, if the attribute to be changed is the size of the open-bigram term being displayed, then those open-bigram terms with an ordinal position falling in the left field of vision will be changed to a first different size, while the open-bigram terms with an ordinal position falling in the right field of vision will be changed to a second different size that is also different than the first different size.

The present subject matter is further described in the following non-limiting examples.

### Example 1

### Inductively Inferring the Next Open-Bigram Term of an Alphabetical Open-Bigram Terms Sequence

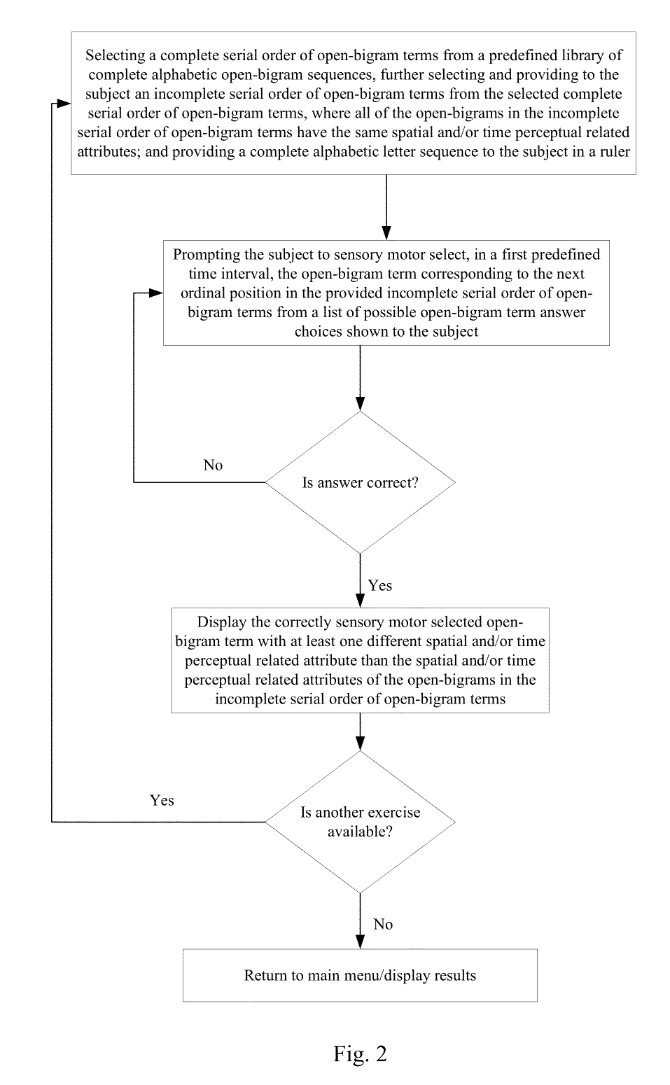

A goal of the exercise presented in Example 1 is to exercise elemental fluid intelligence ability namely, “inductive reasoning”. Specifically, the presented Example 1 exercises a subject ability to inductively infer the next open-bigram term in a provided direct alphabetical open-bigram terms sequence or inverse alphabetical open-bigram terms sequence. FIG. 2 is a flow chart setting forth the method that the present exercises use in promoting fluid intelligence abilities in a subject by inductively inferring the next open-bigram term.

As can be seen in FIG. 2, the method of promoting inductive reasoning ability in the subject comprises selecting a serial order of open-bigram terms from a predefined library of complete alphabetic open-bigram terms sequences, and further selecting an incomplete serial order of open-bigram terms from the selected complete alphabetic serial order of open-bigram terms. All of the open-bigram terms in the incomplete serial order of open-bigram terms have the same spatial and time perceptual related attributes. The subject is then prompted to sensory motor select, in a first predefined time interval, the correct open-bigram term corresponding to the next ordinal position in the sequence of the incomplete serial order of open-bigram terms, from a given list of open-bigram terms as potential answers shown to the subject. If the sensory motor selection made by the subject is a correct sensory motor selection, then the correctly sensory motor selected open-bigram term is displayed with a spatial or time perceptual related attribute different than the spatial or time perceptual related attributes of the incomplete serial order of open-bigram terms. If the sensory motor selection made by the subject is an incorrect sensory motor selection, then the subject is returned to the step of being prompted to sensory motor select the correct open-bigram term corresponding to the next ordinal position in the sequence of the incomplete serial order of open-bigram terms.

The above steps in the method are repeated for a predetermined number of iterations separated by one or more predefined time intervals, and upon completion of the predetermined number of iterations, the subject is provided with each iteration results. The predetermined number of iterations can be any number needed to establish that a satisfactory reasoning performance concerning the particular task at hand is being promoted within the subject. Non-limiting examples of number of iterations include 1, 2, 3, 4, 5, 6, and 7. However, any number of iterations can be performed, like 1 to 23.

In another aspect of Example 1, the method of promoting inductive reasoning ability in a subject is implemented through a computer program product. In particular, the subject matter in Example 1 includes a computer program product for promoting inductive reasoning ability in a subject, stored on a non-transitory computer-readable medium which when executed causes a computer system to perform a method. The method executed by the computer program on the non-transitory computer readable medium comprises selecting a serial order of open-bigram terms from a predefined library of complete alphabetic open-bigram sequences, and further selecting an incomplete serial order of open-bigram terms from the selected complete alphabetic open-bigram sequence. All of the selected symbols in the incomplete serial order of open-bigram terms have the same spatial and time perceptual related attributes. The subject is then prompted to sensory motor select, in a first predefined time interval, the correct open-bigram term corresponding to the next ordinal position in the sequence of the incomplete serial order of open-bigram terms, from a given list of open-bigram terms as potential answers shown to the subject. If the sensory motor selection made by the subject is a correct sensory motor selection, then the correctly sensory motor selected open-bigram term is displayed with a spatial or time perceptual related attribute different than the spatial or time perceptual related attributes of the incomplete serial order of open-bigram terms. If the sensory motor selection made by the subject is an incorrect sensory motor selection, then the subject is returned to the step of being prompted to sensory motor select the correct open-bigram term corresponding to the next ordinal position in the sequence of the incomplete serial order of open-bigram terms. The above steps in the method are repeated for a predetermined number of iterations separated by one or more predefined time intervals, and upon completion of the predetermined number of iterations, the subject is provided with each iteration results.

In a further aspect of Example 1, the method of promoting inductive reasoning ability in a subject is implemented through a system. The system for promoting inductive reasoning ability in a subject comprises: a computer system comprising a processor, memory, and a graphical user interface (GUI), the processor containing instructions for: selecting a serial order of open-bigram terms from a predefined library of complete alphabetic open-bigram sequences, and further selecting an incomplete serial order of open-bigram terms from the selected complete alphabetic open-bigram sequence, wherein all open-bigram terms in the incomplete serial order of open-bigram terms have the same spatial and time perceptual related attributes; prompting the subject on the GUI to correctly sensory motor select, in a first predefined time interval, the open-bigram term corresponding to the next ordinal position in the sequence of the incomplete serial order of open-bigram terms, from a given list of open-bigram terms as potential answers shown to the subject; if the sensory motor selection made by the subject is a correct sensory motor selection, then displaying the correctly sensory motor selected open-bigram term on the GUI with a spatial or time perceptual related attribute different than the spatial or time perceptual related attributes of the incomplete serial order of open-bigram terms; if the sensory motor selection made by the subject is an incorrect sensory motor selection, then returning to the step of prompting the subject; repeating the above steps for a predefined number of iterations separated by one or more predefined time intervals; and upon completion of a predefined number of iterations, providing the subject with the results of all iterations.

For this non-limiting Example 1, the Example includes 4 block exercises. Each block exercise comprises 8 sequential trial exercises. In each trial exercise, a sequence of open-bigram terms is presented to the subject for a brief period of time. Without delay, upon seeing this open-bigram terms sequence, the subject is required to inductively infer what would be the next open-bigram term following the last open-bigram term presented in the open-bigram term sequence. When the open-bigram terms sequences are selected from direct or inverse alphabetic sequences, the open-bigram term members of the selected alphabetical sequences are pairs of consecutive letters in the alphabetic sequences. More so, the present task has been designed to reduce cognitive workload by minimizing the dependency of the subject's reasoning or inferring skills on real-time manipulation of symbolic sequential information by the subject's working memory; therefore for each trial exercise, four open-bigram term option answers are also displayed, from which the subject is requested to choose each time a single correct next open-bigram term answer.

The subject is given a first predefined time interval within which the subject must validly perform the exercises. If the subject does not perform a given exercise within the first predefined time interval, also referred to as “a valid performance time period”, then after a delay, which could be about 2 seconds, the next in-line open-bigram term sequence type for the subject to perform is displayed. In one embodiment, the first predefined time interval or maximal valid performance time period allowed for a subject's lack of response is defined to be 10-20 seconds, in particular 15-20 seconds, and further specifically 17 seconds.

In the present Example, there are second predefined time intervals between block exercises. Let Δ1 herein represent a time interval between block exercises' performances of the present task, where Δ1 is herein defined to be of 8 seconds. However, other time intervals are also contemplated, including without limitation, 5-15 seconds and the integral times there between.

In an aspect of the exercises of Example 1, the selection of the alphabetic serial order of open-bigram terms is done at random, from predefined complete alphabetic open-bigram sequences in a library. Selection of the incomplete serial order of open-bigram terms is done also at random, from predefined number of open-bigram terms and predefined ordinal positions of these open-bigram terms, in the previously selected complete alphabetic open-bigram sequence. While this aspect of the exercises is easier to implement through the use of a computer program, it is also understood that the random selection of the serial order of open-bigram terms is also achievable manually.

In the exercises of Example 1, when alphabetic serial orders are utilized, incomplete serial orders made up by alphabetic open-bigram terms sequences are provided according to two types of predefined sequences: 1) a direct alphabetical sequence and 2) an inverse alphabetical sequence. Still, each direct alphabetical or inverse alphabetical sequence type initially displays, as a default, three open-bigram terms of the alphabetic letter sequences. It is understood that the incompleteness of a direct alphabetic open-bigram term sequence is in relation to the direct alphabetic set array of the English alphabetical sequence consisting of A-Z individual letter symbols, while the incompleteness of an inverse alphabetic open-bigram term sequence is in relation to the inverse alphabetic set array of the English alphabetical sequence consisting of Z-A individual letter symbols. Furthermore, for the exercises of Example 1, the open-bigram terms are generally provided in their upper case (or capital) font form, for example open-bigram terms AB, CD, etc.

The alphabetical serial orders are provided to the subject in a way such that each member of the direct alphabetical serial order or inverse alphabetical serial order is provided as an open-bigram term of two-consecutive letter symbols. In embodiments, the open-bigram terms can be provided as two consecutive letter symbols, or as two non-consecutive letter symbols.

The direct alphabetical serial order of letter symbols or inverse alphabetical serial order of letter symbols comprising each open-bigram term can be made of consecutive letter symbols. In an alternative aspect, the direct alphabetical letter serial order of symbols or inverse alphabetical letter serial order of symbols of each open-bigram term, can be made comprising non-consecutive letter symbols.

For each block exercise of Example 1, a total of eight incomplete serial orders of open-bigram terms are provided to the subject. In an embodiment, from the eight incomplete serial orders of open-bigram terms provided to the subject, four of the incomplete serial orders of open-bigram terms are from a direct alphabetic sequence and four of the incomplete serial orders of open-bigram terms are from an inverse alphabetic sequence. In another non-limiting case, the direct alphabetical serial orders of open-bigram terms and inverse alphabetical serial orders of open-bigram terms are not presented in a predefined order, meaning that the subject is provided randomly with either a direct alphabetical serial order of open-bigram terms or an inverse alphabetical serial order of open-bigram terms.

In providing the exercises in Example 1, a length of the original incomplete serial order of open-bigram terms is 2-6 open-bigram terms prior to the sensory motor selecting of the next correct open-bigram term by the subject. In another aspect of the present exercises, the length of the original incomplete serial order of open-bigram terms is 3 open-bigram terms prior to the sensory motor selecting of the next correct open-bigram term by the subject.

As discussed above, upon sensory motor selection of the correct answer by the subject, the correct serial order of open-bigram terms is then displayed with the correctly sensory motor selected open-bigram term being displayed with a spatial or time perceptual related attribute different than the spatial or time perceptual related attributes of the provided incomplete serial order of open-bigram terms. The changed spatial or time perceptual related attribute of the 2 symbols comprising the correct sensory motor selected open-bigram term answer is selected from the group of spatial or time related perceptual attributes, which includes symbol font color, symbol sound, symbol font size, symbol font style, symbol font critical spacing, symbol font case, symbol font boldness, symbol font angle of rotation, symbol font mirroring, or combinations thereof. Furthermore, the correctly sensory motor selected symbols of the open-bigram term may be displayed with a time related perceptual attribute “flickering” behavior in order to further highlight the differences in spatial or time perceptual related attributes.

As previously indicated above with respect to the general methods for implementing the present subject matter, the exercises in Example 1 are useful in promoting fluid intelligence abilities in the subject by enabling the grounding of cognitive behavior through the joint interactions of the sensorial-motor and perceptual domains when the subject performs the given exercise. That is, mental inductive reasoning behavior on the fly coupled with sensorial visual perceptual serial discrimination of open-bigram terms by the subject engages goal oriented body movements to execute the correct sensory motor selecting of the next open-bigram term in an incomplete sequence of open-bigram terms and combinations thereof. The goal oriented motor activity engaged within the subject may be any goal oriented motor activity jointly involved in the sensorial perception of the sequential complete and incomplete serial order of open-bigram terms. While any body movements can be considered goal oriented motor activity implemented by the subject, the present subject matter is mainly concerned with implemented goal oriented body movements selected from the group consisting of goal oriented body movements of the subject's eyes, head, neck, arms, hands, fingers and combinations thereof.

By requesting that the subject engage in specific degrees of goal oriented body sensory motor activity, the exercises of Example 1 are requiring the subject to bodily-ground cognitive fluid intelligence abilities. The exercises of Example 1 cause the subject to revisit an early developmental realm where he/she accidentally acted/experienced enactment of fluid cognitive abilities when performing serial pattern recognition of non-concrete terms/symbols meshing with their salient spatial-time perceptual related attributes. The established sequential relationships between these non-concrete terms/symbols and their salient spatial and/or time perceptual related attributes heavily promote symbolic knowhow in a subject. By doing this, the exercises of Example 1 strengthen the ability to infer the next open-bigram term in an incomplete series of open-bigram terms through inductive reasoning within the subject. It is important that the exercises of Example 1 accomplish this downplaying or mitigating as much as possible the subject need to recall-retrieve and use verbal semantic or episodic memory knowledge in order to support or assist his/her inductive reasoning strategies to problem solving of the exercises in Example 1. The exercises of Example 1 are mainly within promoting fluid intelligence in general and inductive reasoning ability in particular in the subject, but do not rise to a learning operational level where crystalized intelligence is promoted mainly via the subject engaging in explicit associative learning corroborated by declarative semantic knowledge. As such, the specific letters sequence and unique serial orders of open-bigram terms are herein selected to purposely downplay or mitigate the subject's need for developing problem solving strategies and/or drawing inductive-deductive inferences necessitating the generation of verbal knowledge and/or recall-retrieval of information from declarative-semantic and/or episodic kinds of past consolidated memories.

In a further aspect of the exercises of present Example 1, the library of complete sequences may also include the following complete sequences: direct alphabetic set array, inverse alphabetic set array, direct type of alphabetic set array, inverse type of alphabetic set array, central type of alphabetic set array, and inverse central type of alphabetic set array. It is understood that the above library of complete sequences may contain additional set arrays sequences or fewer set arrays sequences than those listed above.

In the main aspect of the exercises present in Example 1, the library of complete sequences comprises open-bigram terms sequences. An open-bigram term sequence is a sequence of terms wherein the single letter symbols are presented as pairs. In this main aspect of the present subject matter, the library of complete sequences comprises the following complete alphabetic sequential orders of open-bigram terms: direct open-bigram set array; inverse open-bigram set array; direct type open-bigram set array; inverse type open-bigram set array; central type open-bigram set array; inverse central type open-bigram set array. It is understood that the above library of complete sequences may contain additional open-bigram set arrays sequences or fewer open-bigram set array sequences than those listed above.

Furthermore, it is also important to consider that the exercises of Example 1 are not limited to alphabetic symbols in the serial orders of open-bigram terms. It is also contemplated that the exercises are also useful when numeric serial orders and/or alpha-numeric serial orders are used within the exercises. In other words, while the specific examples set forth employ serial orders of open-bigram terms (comprised of a pair of letters), it is also contemplated that serial orders of open-bigram terms comprising numbers and/or alpha-numeric symbols can be used.

In an aspect of the present subject matter, the exercises of Example 1 include providing a graphical representation of an open-bigram set array, in a ruler shown to the subject, when providing the subject with an incomplete direct alphabetic open-bigram terms sequence or an incomplete inverse alphabetic open-bigram terms sequence. The visual presence of the ruler helps the subject to perform the exercise, by facilitating a fast visual spatial recognition of the presented open-bigram terms sequence, in order to efficiently assist the subject to sensorially discriminate and inductively correctly infer the next open-bigram term. In the present exercises, the ruler comprises one of a plurality of sequences in the above disclosed library of complete sequences, namely direct alphabetic set array; inverse alphabetic set array; direct type of alphabetic set array; inverse type of alphabetic set array; central type of alphabetic set array; inverse central type of alphabetic set array; direct open-bigram set array; inverse open-bigram set array; direct type open-bigram set array; inverse type open-bigram set array; central type open-bigram set array; and inverse central type open-bigram set array.

The methods implemented by the exercises of Example 1 also contemplate those situations in which the subject fails to perform the given task. The following failing to perform criteria is applicable to any trial exercise in any block exercise of the present task in which the subject fails to perform. Specifically, for the present exercises, there are two kinds of “failure to perform” criteria. The first kind of “failure to perform” criteria occurs in the event the subject fails to perform by not sensory motor click-selecting (the subject remains inactive/passive) with the hand-held mouse device on the valid or invalid next open-bigram term choice displayed (among 4 next open-bigram term choices), within a valid performance time period, then after a delay, which could be of about 2 seconds, the next in-line open-bigram term sequence type trial exercise for the subject to perform is displayed. In some embodiments, this valid performance time period is defined to be specifically 17 seconds.

The second “failure to perform” criteria is in the event the subject fails to perform by sensory motor selecting consecutively twice on the wrong next-term open-bigram term choice displayed. More so, as an operational rule applicable for any failed trial exercise of the present task, failure to perform results in the automatic displaying of the next in-line require to perform open-bigram terms sequence type trial exercise, for the subject to correctly infer the next open-bigram term. However, in the event the subject fails to correctly infer the next open-bigram term answer choice for any herein required to perform incomplete serial orders of open-bigram terms in excess of 2 non-consecutive trial exercises (in a single block exercise), then one of the following two options will occur: 1) if the failure to perform is for more than 2 non-consecutive trial exercises (in a single block exercise of Example 1), then the subject's current block-exercise performance is immediately halted and after a time interval of about 2 seconds, the next in-line herein require to perform open-bigram term sequence type in its respective trial exercise will immediately be displayed (for the subject to perform) in the next in-line block exercise; or 2) (which is only relevant for the last block exercise of Example 1) the subject will be immediately exited from the remainder of the fourth block exercise and returned back to the main menu of the computer program.

The total duration to complete the exercises of Example 1, as well as the time it took to implement each of the individual trial exercises, is registered in order to help generate an individual and age-gender group related performance score. Records of all wrong inferred next open-bigram term choice answers for all of the types of open-bigram sequences displayed and required to be performed are also generated and displayed. In general, the subject will perform this task about 6 times during his/her language based brain neuroperformance-fitness training program.

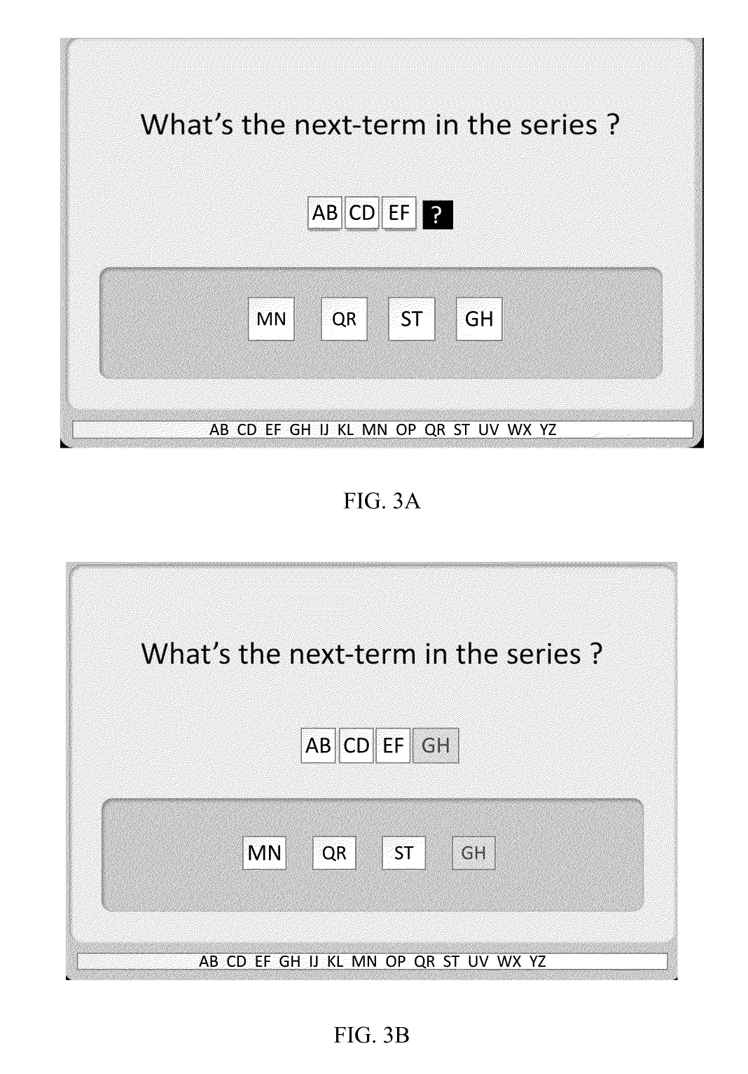

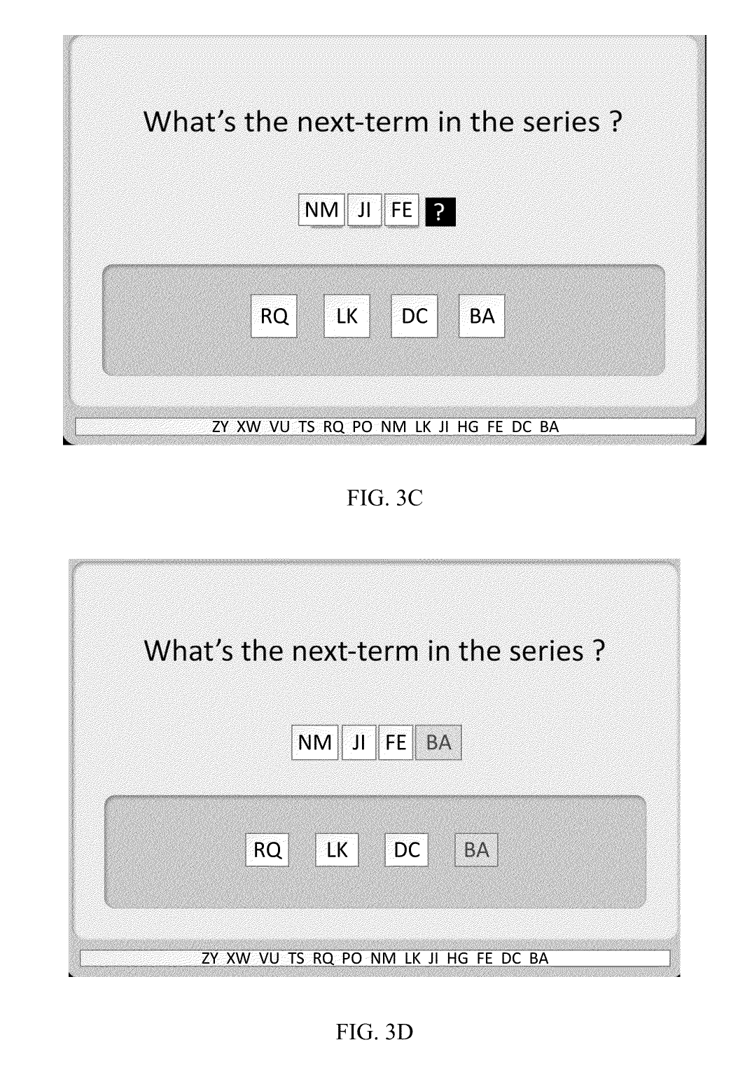

FIGS. 3A-3D depicts a number of non-limiting examples of the exercises for inductively inferring the next open-bigram term in an incomplete serial order of open-bigram terms. FIG. 3A shows a direct alphabetical serial order of open-bigram terms comprising three open-bigram terms and prompts the subject to correctly sensory motor select the fourth open-bigram term. In this case, the subject is provided with AB, CD, and EF open-bigram terms and given the open-bigram terms MN, QR, ST, and GH as possible answer choices for sensory motor selecting the next open-bigram term. FIG. 3B shows that the correct sensory motor selection is the open-bigram term GH. As can be seen, the open-bigram term GH replaces the question mark in the original incomplete serial order of open-bigram terms and is highlighted by changing the time perceptual related attribute of font color. The correct sensory motor selection in the given possible answers is also highlighted by changing the time perceptual related attribute of font color. It is understood that other spatial or time perceptual related attributes could also be changed to highlight the correct sensory motor selected answer.

As is explained above, the provided incomplete serial order of open-bigram terms can be either direct alphabetical or inverse alphabetical. Likewise, the provided incomplete serial order of open-bigram terms can comprise consecutive letter symbols or non-consecutive letter symbols.

FIG. 3C shows an inverse alphabetical serial order of symbols comprising open-bigram terms. In this case, the subject is provided with open-bigram terms NM, JI, and FE, and given the open-bigram terms RQ, LK, DC, and BA as possible answer choices for sensory motor selecting the next open-bigram term. FIG. 3D shows that the correct sensory motor selection is the open-bigram term BA. As can be seen, the open-bigram term BA replaces the question mark in the original open-bigram term sequence and is highlighted by changing the time perceptual related attribute font color. The correct sensory motor selection in the given possible answers is also highlighted by changing the time perceptual related attribute font color. It is further understood that other spatial or time perceptual related attributes could also be changed to highlight the correct sensory motor selected answer.

As is shown in this exercise, the incomplete serial order of open-bigram terms provided to the subject is a consecutive direct alphabetical letter sequence in FIGS. 3A-3B and a non-consecutive inverse alphabetical letter sequence in FIGS. 3C-3D. It is understood that the provided incomplete serial orders of open-bigram terms could also be either of a non-consecutive direct alphabetical letter sequence and a consecutive inverse alphabetical letter sequence.

### Example 2

### Fluid Intelligence Ability to Efficiently Sensorially Discriminate Sameness Versus Differentness Between Sequences of Open-Bigram Terms

The goal of the present exercises of Example 2 is to efficiently exercise a fundamental root based cognitive fluid intelligence skill related to the ability of quickly and accurately sensorially discriminating commonness versus non-commonness between two pattern sequences of open-bigram terms displayed simultaneously. Specifically, the aim of the present exercises is to steer the subject's reasoning ability to focus on efficiently grasping sameness versus differentness concerning sequential pattern properties of two sequences of open-bigram terms and the specific spatial or time perceptual related attributes of their open-bigram term symbols. The present task also exercises the subject's reasoning/grasping ability to pick-up in the blink of an eye, if existing, common (implicit) rules that characterize both open-bigram term sequences. Accordingly, the goal is mainly concerned with finding out if the presented open-bigram terms sequences are: 1) identical or 2) different. To that effect, in a non-limiting aspect of Example 2, the subject is presented with an incomplete alphabetic sequence of open-bigram terms with a various number of open-bigram terms from a direct alphabetic open-bigram set array consisting of A-Z letters symbols and/or from an incomplete inverse alphabetic open-bigram set array consisting of Z-A letters symbols.

In the context of the present exercises, it is important to clarify the definition of sameness or differentness of open-bigram terms making up the alphabetical direct or inverse open-bigram term sequences. Both same and different incomplete open-bigram terms sequences from direct alphabetic and inverse alphabetic open-bigram set arrays displayed in any trial exercise herein comprise a set of same open-bigram terms and same number of open-bigram terms. Therefore, in the specific context of the present exercises, the mental conceptualization and sensory motor implementation of being ‘different’ does not only or simply mean that an incomplete open-bigram terms sequence from a direct or inverse alphabetic open-bigram set array possesses: 1) at least one altered open-bigram term in the open-bigram term sequence, as for example AB≠AT; or 2) at least one open-bigram term in excess or lacking in the open-bigram sequence, as for example AB≠AB, CD or AB, CD≠AB.

Still, in the specific context of the present exercises, the mental conceptualization and required sensory motor implementation of open-bigram terms being ‘identical’ does not only or simply mean two open-bigram term sequences that entail, for example, same repeated open-bigram terms. Rather, sameness or differentness of open-bigram term sequences are linked to open-bigram terms' sequential relationships manifesting related, correlated, or cross-correlated properties of their letter symbols' spatial or time perceptual related salient attributes amongst the open-bigram terms of the two open-bigram term sequences, and require the following considerations: 1) at least one open-bigram term of the two open-bigram terms sequences could have a different spatial or time perceptual related attribute, 2) when reasoning to try to problem solve sameness or difference between two open-bigram terms sequences, same open-bigram (letter) terms and the number of same open-bigram terms should be considered; 3) according to 1 and 2 above, when the subject is required to reason and sensorially discriminate differentness among two open-bigram term sequences, one open-bigram term must have at least one salient altered spatial or time perceptual related attribute in relation to the open-bigram terms in the other open-bigram terms sequence; and 4) according to 1 and 2 above, when the subject is required to reason and sensorially discriminate sameness among two open-bigram terms sequences, all letter symbols in their respective open-bigram terms sequences must not differ in a single spatial or time perceptual related attribute.

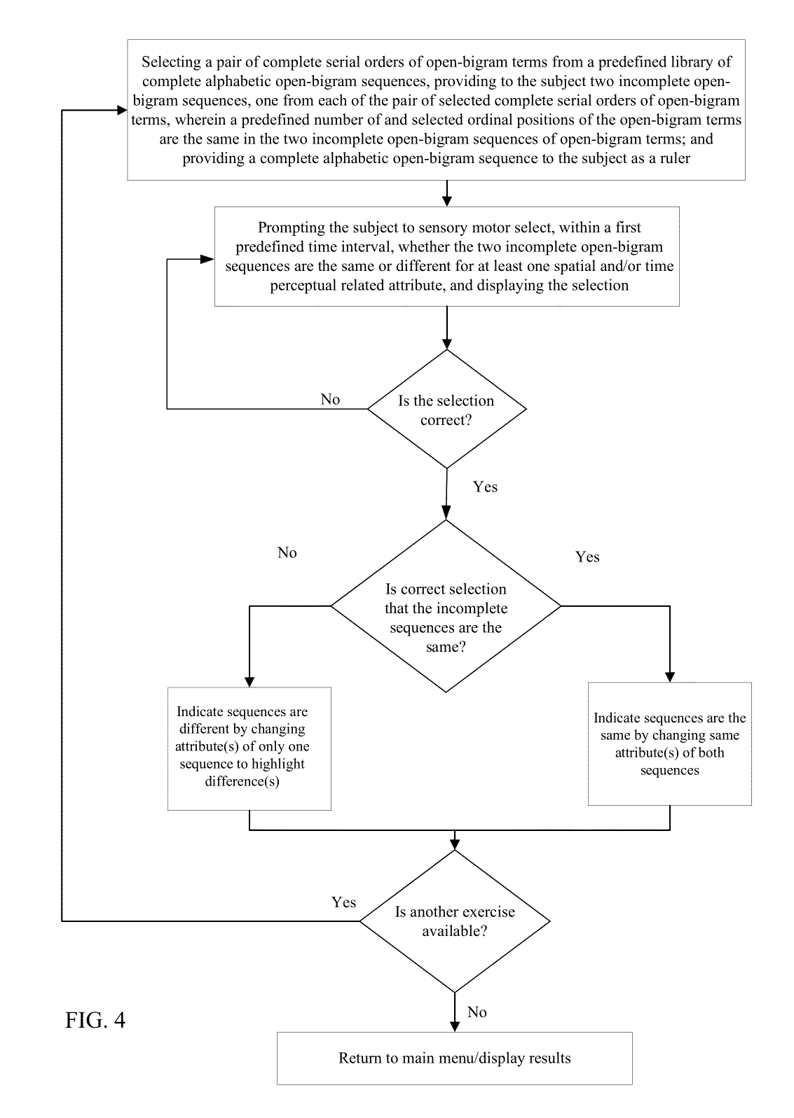

FIG. 4 is a flow chart setting forth the method that the present exercises use in promoting fluid intelligence abilities in a subject. In the present exercise the subject reasons about the similarity or disparity in open-bigram terms sequences. As can be seen in FIG. 4, the method of promoting fluid intelligence reasoning ability in the subject comprises selecting a pair of serial orders of open-bigram terms from a predefined library of complete alphabetic open-bigram terms sequences and providing the subject with these two sequences of symbols, one from each of the pair of selected serial order of open-bigram terms. A predefined number of open-bigram terms and the selected ordinal positions of these open-bigram terms are the same in the two provided sequences of open-bigram terms. The subject is then prompted to sensory motor select, within a first predefined time interval, whether the two provided sequences of open-bigram terms are the same, or different in at least one of their spatial or time perceptual related attributes, and the selection is displayed. If the sensory motor selection made by the subject is an incorrect sensory motor selection, then the subject is returned to the step of selecting a pair of serial orders of open-bigram terms. If the sensory motor selection made by the subject is a correct sensory motor selection and the correct sensory motor selection is that the two sequences of open-bigram terms are the same, then the correct sensory motor selection is displayed with an indication that the two sequences of symbols are the same by changing at least one spatial or time perceptual related attribute in both sequences of open-bigram terms. If the sensory motor selection made by the subject is a correct sensory motor selection and the correct sensory motor selection is that the two provided sequences of open-bigram terms are different, then the correct sensory motor selection is displayed with an indication that the two provided sequences of open-bigram terms are different by changing at least one spatial or time perceptual related attribute of only one sequence of open-bigram terms, to highlight the salient difference between the two provided sequences of open-bigram terms.

The above steps of the method are repeated for a predetermined number of iterations separated by one or more predefined time intervals, and upon completion of the predetermined number of iterations, the subject is provided with each iteration results. The predetermined number of iterations can be any number needed to establish that a satisfactory reasoning performance concerning the particular task at hand is being promoted within the subject. Non-limiting examples of number of iterations include 1, 2, 3, 4, 5, 6, and 7. However, any number of iterations can be performed, like 1 to 23.

In another aspect of Example 2, the method of promoting fluid intelligence reasoning ability in a subject is implemented through a computer program product. In particular, the subject matter of Example 2 includes a computer program product for promoting fluid intelligence reasoning ability in a subject, stored on a non-transitory computer-readable medium which when executed causes a computer system to perform a method. The method executed by the computer program product on the non-transitory computer readable medium comprises selecting a pair of serial orders of open-bigram terms from a predefined library of complete alphabetic open-bigram terms sequences and providing the subject with two sequences of open-bigram terms, one from each of the pair of selected serial order of open-bigram terms. A predefined number of open-bigram terms and selected ordinal positions of these open-bigram terms are the same in the two provided sequences of open-bigram terms. The subject is then prompted to sensory motor select, within a first predefined time interval, whether the two provided sequences of open-bigram terms are the same, or different in at least one of their spatial or time perceptual related attributes, and the selection is displayed.

If the sensory motor selection made by the subject is an incorrect sensory motor selection, then the subject is returned to the step of selecting a pair of serial orders of open-bigram terms. If the sensory motor selection made by the subject is a correct sensory motor selection and the correct sensory motor selection is that the two provided sequences of open-bigram terms are the same, then the correct sensory motor selection is displayed with an indication that the two provided sequences of open-bigram terms are the same by changing at least one spatial or time perceptual related attribute in both sequences of open-bigram terms. If the sensory motor selection made by the subject is a correct sensory motor selection and the correct sensory motor selection is that the two provided sequences of open-bigram terms are different, then the correct sensory motor selection is displayed with an indication that the two provided sequences of open-bigram terms are different by changing at least one spatial or time perceptual related attribute of only one sequence of open-bigram terms, to highlight the difference between the two provided sequences of open-bigram terms. The above steps of the method are repeated for a predetermined number of iterations separated by one or more predefined time intervals, and upon completion of the predetermined number of iterations, the subject is provided with each iteration results.

In a further aspect of Example 2, the method of promoting fluid intelligence reasoning ability in a subject is implemented through a system. The system for promoting fluid intelligence reasoning ability in a subject comprises: a computer system comprising a processor, memory, and a graphical user interface (GUI), the processor containing instructions for: selecting a pair of serial orders of open-bigram terms from a predefined library of complete alphabetic open-bigram terms sequences and providing the subject on the GUI with two sequences of open-bigram terms, one from each of the pair of selected serial orders of open-bigram terms, wherein a predefined number of open-bigram terms and selected ordinal positions of these open-bigram terms are the same in the two sequences of open-bigram terms; prompting the subject on the GUI to sensory motor select, within a first predefined time interval, whether the two provided sequences of open-bigram terms are the same, or different in at least one of their spatial or time perceptual related attributes, and displaying the selection; if the sensory motor selection made by the subject is an incorrect sensory motor selection, then returning to the step of selecting a pair of serial orders of open-bigram terms; if the sensory motor selection made by the subject is a correct sensory motor selection and the correct sensory motor selection is that the two provided sequences of open-bigram terms are the same, then displaying the correct sensory motor selection on the GUI and indicating that the two provided sequences of open-bigram terms are the same by changing at least one spatial or time perceptual related attribute in both sequences of open-bigram terms; if the sensory motor selection made by the subject is a correct sensory motor selection and the correct sensory motor selection is that the two provided sequences of open-bigram terms are different, then displaying the correct sensory motor selection on the GUI and indicating that the two provided sequences of open-bigram terms are different by changing at least one spatial or time perceptual related attribute of only one sequence of open-bigram terms, to highlight the difference between the two provided sequences of open-bigram terms; repeating the above steps for a predetermined number of iterations separated by one or more predefined time intervals; and upon completion of the predetermined number of iterations, providing the subject with each iteration results.

In an aspect of the exercises of Example 2, the selection of the pair of serial orders of open-bigram terms is done at random, from a predefined library of complete alphabetic serial orders of open-bigram terms, and selection of the two incomplete open-bigram sequences is done also at random, from a predefined number of open-bigram terms and predefined ordinal positions of these open-bigram terms, in the previously selected pair of complete alphabetic serial orders of open-bigram terms. While this aspect of the exercises is easier to implement through the use of a computer program, it is also understood that the random selection of the serial order of open-bigram terms is also achievable manually.

The subject is given a predefined time interval within which the subject must validly perform the exercises. If the subject remains passive, and for whatever reason does not perform the exercise within the predefined time interval, also referred to as “a valid performance time period”, then after a delay, which could be of about 4 seconds, the next in-line open-bigram terms sequence type for the subject to perform is displayed. In an embodiment, this predefined time interval or maximal valid performance time period for lack of response, is defined to be 10-60 seconds, in particular 30-50 seconds, and further specifically 45 seconds.

In the present Example, there are also predefined time intervals between block exercises. Let Δ1 herein represent a time interval between block exercises' performances of the present task, where Δ1 is herein defined to be of 8 seconds. However, other time intervals between block exercises are also contemplated, including without limitation, 5-15 seconds and the integral times there between.

In a non-limiting embodiment, Example 2 includes four block exercises. Each block exercise comprises six trial exercises that are displayed sequentially. In block exercises #1-#4, each trial exercise displays, for a brief period of time, incomplete alphabetic open-bigram terms sequences in the following manner 1) two from A-Z letter symbols sequences, meaning from direct alphabetic set arrays; or 2) two from inverse alphabetic Z-A set arrays. Consequently, upon seeing and reasoning about these two incomplete direct alphabetic or two incomplete inverse alphabetic open-bigram terms sequences from set arrays, and being displayed during a predefined time window, the subject is required, without delay, to quickly sensory motor select if the pattern of the open-bigrams terms sequences and the spatial or time perceptual related attributes of the two presented open-bigram terms sequences are: 1) identical (according to criteria and rules explained above) or 2) different (according to criteria and rules explained above). Subsequently, for case 1) above, the subject reasons and sensory motor selects as fast as possible the option that the two displayed open-bigram term sequences are the “same”, thus immediately ending the current exercise; or, if case 2) above was presented, the subject reasons and sensory motor selects as fast as possible that the two displayed open-bigram term sequences are “different”, thus immediately ending the current exercise. All exercises in all block exercises #1-#4 follow the same operational procedure as explained above.

The incomplete open-bigram terms sequence from a direct alphabetic open-bigram set array or the incomplete open-bigram terms sequence from an inverse alphabetic open-bigram set array can be made of consecutive ordinal positions of open-bigram terms members of the arrays or, in an alternative aspect, can be made of non-consecutive ordinal positions of the open-bigram terms members of the set arrays.

As discussed above, if the sensory motor selection made by the subject is a correct sensory motor selection where the two patterns of open-bigram terms in the sequences are the same, then the correct sensory motor selection is displayed with an indication that the two patterns of open-bigram terms in the sequences are the same by changing at least one same spatial or time perceptual related attribute in both sequences of open-bigram terms. The changed spatial or time perceptual related attribute of the correct sensory motor selected answer is selected from the group of spatial or time perceptual related attributes, or combinations thereof. In a particular aspect, the changed spatial or time perceptual related attributes are selected from the group consisting of symbol font color, symbol sound, symbol font size, symbol font style, symbol font critical spacing, symbol font case, symbol font boldness, symbol font angle of rotation, symbol font mirroring, or combinations thereof. Furthermore, the correct sensory motor selection revealing that the two patterns of open-bigram term sequences are the same may be further displayed with time perceptual related attribute font flickering behavior to further highlight the sameness of the open-bigram term sequences in their spatial and time perceptual related attributes.

Similarly, if the sensory motor selection made by the subject is a correct sensory motor selection where the two patterns of open-bigram terms in the displayed sequences are different in at least one spatial or time perceptual related attribute, then the correct sensory motor selection is displayed with an indication that the two patterns of open-bigram terms sequences are different by changing at least one spatial or time perceptual related attribute of only one pattern of open-bigram terms in one of the sequences to highlight the difference between the two patterns of open-bigram terms in the displayed sequences. The changed spatial or time perceptual related attribute of the symbols in the correct sensory motor selected answer is selected from the group consisting of spatial or time perceptual related attributes or combinations thereof. In particular, the changed spatial or time perceptual related attribute is selected from the group consisting of symbol font color, symbol sound, symbol font size, symbol font style, letter symbol font spacing, letter symbol font case, letter symbol font boldness, letter symbol font angle of rotation, letter symbol font mirroring, or combinations thereof. Furthermore, the correctly sensory motor selected open-bigram terms answer may be displayed with a time perceptual related attribute flickering behavior in order to further highlight the differences in spatial and time perceptual related attributes.

For those exercises in which the two patterns of open-bigram terms sequences are different, the difference between the two patterns of open-bigram terms can be at least one different spatial or time perceptual related attribute amongst their respective letter symbols. The at least one different spatial perceptual related attribute amongst the two open-bigram terms sequences can be any spatial perceptual related attribute previously discussed herein, namely an attribute selected from the group consisting of symbol font size, symbol font style, letter symbol font spacing, letter symbol font case, letter symbol font boldness, letter symbol font angle rotation, letter symbol font mirroring, or combinations thereof. These attributes are considered spatial perceptual related attributes of the letter symbols making up the open-bigram term. The at least one attribute different among the two patterns of open-bigram term sequences can be any attribute previously discussed herein, namely an attribute selected from the time perceptual related attributes of the letter symbols consisting of symbol font color, symbol sound, and symbol font flickering. Other spatial perceptual related attributes of letter symbols that may be used to sensorially discern sameness and/or differentness between two patterns of open-bigram term sequences include, without limitation, letter symbol font vertical line of symmetry, letter symbol font horizontal line of symmetry, letter symbol font vertical and horizontal lines of symmetry, letter symbol font infinite lines of symmetry, and letter symbol font with no line of symmetry.

A further difference that can be a basis for the subject to see, reason, and sensory motor select that the two patterns of open-bigram terms are different is the change in the alphabetic serial order of the open-bigram terms between the two open-bigram terms patterns. In other words, if the subject sees that the open-bigram terms within the two patterns of open-bigram term sequences are not positioned in the same serial order, then the subject should reason and sensory motor select that the two patterns of open-bigram terms are different.

In each one of block exercises #1-#4, there are six trial exercises, where each trial exercise displays two incomplete alphabetic open-bigram terms sequences, for a total of 12 incomplete alphabetic open-bigram terms sequences are displayed in each block exercise. In embodiments where open-bigram term sequences are not randomly selected, within the 12 incomplete alphabetic open-bigram term sequences, six incomplete alphabetic open-bigram term sequences are from direct alphabetic set arrays, and six incomplete alphabetic open-bigram term sequences are from inverse alphabetic set arrays. In general, the total number of incomplete alphabetic open-bigram term sequences from direct and inverse alphabetic set arrays to be displayed to the subject is 48, and the subject is requested to perform the exercises accordingly. Furthermore, each of the two patterns of open-bigram terms in the incomplete alphabetic open-bigram terms sequences for each trial exercise comprise 2-7 open-bigram terms. Particularly, each of the two patterns of open-bigram terms in the incomplete alphabetic open-bigram term sequences comprise 3-5 open-bigram terms.

As is the case with respect to the exercises in Example 1, the exercises in Example 2 are useful in promoting fluid intelligence abilities in the subject by grounding the most basic fluid cognitive reasoning faculties in selective goal oriented sensory motor activity that occur when the subject performs in order to problem solve the given open-bigram term sequences exercises. That is, reasoning by the subject in order to sensory motor manipulate or sensorially discriminate same or different sequential orders of open-bigram terms engages goal oriented sensory motor activity within the subject's body. The sensory motor activity engaged within the subject may be any sensory motor activity jointly involved in the sensorial perception of the selected complete and further selected incomplete serial orders of open-bigram terms, goal oriented body movements to correctly execute sensory motor selecting differentness or sameness among open-bigram term sequences based on serial pattern recognition/identification of at least one salient spatial or time perceptual related attribute, and combinations thereof. While any body movements can be considered sensory motor activity within the subject, the present subject matter is particularly concerned with goal oriented body movements selected from the group consisting of goal oriented body movements of the subject's eyes, head, neck, arms, hands, fingers and combinations thereof.

In the exercises present in Example 2, the library of complete open-bigram term sequences comprises set arrays where each member therein is an open-bigram term. An open-bigram sequence is a sequence where the letter symbols that make up an open-bigram term are presented as letter pairs instead of as an individual letter symbol representing each term. In this aspect of the present subject matter, the library of complete open-bigram term sequences comprises the following sequential orders of open-bigrams terms: direct open-bigram set array; inverse open-bigram set array; direct type open-bigram set array; inverse type open-bigram set array; central type open-bigram set array; and inverse central type open-bigram set array. It is understood that the above library of complete open-bigram terms sequences may contain additional set arrays sequences or fewer set arrays sequences than those listed above.

Furthermore, it is also important to consider that the exercises of Example 2 are not limited to serial orders of alphabetic open-bigram terms. It is also contemplated that the exercises are also useful when numeric serial orders and/or alpha-numeric serial orders of open-bigram terms are used within the exercises. In other words, while the specific examples set forth employ alphabetic serial orders of open-bigram terms, it is also contemplated that serial orders of open-bigram terms comprising numbers and/or alpha-numeric symbols can be used.

In an aspect of the present subject matter, the exercises of Example 2 include providing a graphical representation of an open-bigram set array sequence in a ruler shown to the subject. The ruler provided to the subject is the selected from a complete alphabetic open-bigram terms sequence from a direct alphabetic set array or inverse alphabetic set array. The presence of the ruler on the screen helps the subject to perform the exercise by facilitating fast and effortless visual spatial recognition of the presented pattern of open-bigram term sequences in order to assist the subject to reason on the fly about the similarity or disparity between the two presented open-bigram term sequences. In the present exercises, the ruler comprises one of a plurality of open-bigram term sequences from the above disclosed predefined library of set arrays sequences, comprising direct open-bigram set array, inverse open-bigram set array, direct type open-bigram set array, inverse type open-bigram set array, central type open-bigram set array, and inverse central type open-bigram set array.

The methods implemented by the exercises of Example 2 also contemplate those situations in which the subject fails to perform the given task. The following failing to perform criteria is applicable to any trial exercise in any block exercise of the present task in which the subject fails to perform. Specifically, there are two kinds of “failure to perform” criteria for the present exercises. The first kind of “failure to perform” criteria occurs in the event the subject fails to perform for whatever reason by not sensory motor selecting a valid choice of “same” or “different”, within a valid performance time period, then after a delay, which could be of about 4 seconds, the next in-line serial orders of open-bigram terms for the subject to perform is displayed. In some embodiments, this valid performance time period for lack of response is defined to be 10-50 seconds, in particular 15-40 seconds, and further specifically 45 seconds. Failure to perform for lack of a sensory motor response prompts the display of up to three new additional trial exercises to the subject, unless the failure to sensory motor select an answer occurs in the last block exercise, in which case the exercises are terminated and the subject is returned to the main menu of examples.

The second “failure to perform” criteria is in the event the subject fails to perform by sensory motor selecting the wrong choice of “same” or “different”. More so, as an operational rule applicable for any failed trial exercise of the present task, failure to perform results in the automatic displaying of the next in-line require to perform serial order of open-bigram terms in its respective trial exercise for the subject to correctly reason whether the two patterns of open-bigram terms sequences are the same or different. However, in the event the subject fails to correctly reason about symbol spatial or time perceptual related attribute sameness or differentness in excess of 2 non-consecutive trial exercises (in a single block exercise), then one of the following two options will occur: 1) if the failure to perform persists for more than 2 non-consecutive trial exercises (in a single block exercise of Example 2), then the subject's current block exercise performance is immediately halted, and after a time interval of about 4 seconds the next in-line required to perform two patterns of open-bigram term sequences type of the respective trial exercise will immediately be displayed (for the subject to reason-discriminate and perform) in the next in-line block exercise; or 2) (which is only relevant for the last block exercise of Example 2) the subject will be immediately exited from the remainder of the fourth block exercise and returned back to the main menu of the computer program.

The total duration to complete the exercises of Example 2, as well as the time it took to implement each one of the individual trial exercises in their respective block exercises, is registered in order to help generate an individual and age-gender group related performance score. Records of all wrong answers for all types of serial orders of same or different patterns of open-bigram sequences that are displayed are also generated and displayed. In general, the subject will perform this task about 6 times during his/her language based brain neuroperformance-fitness training program.

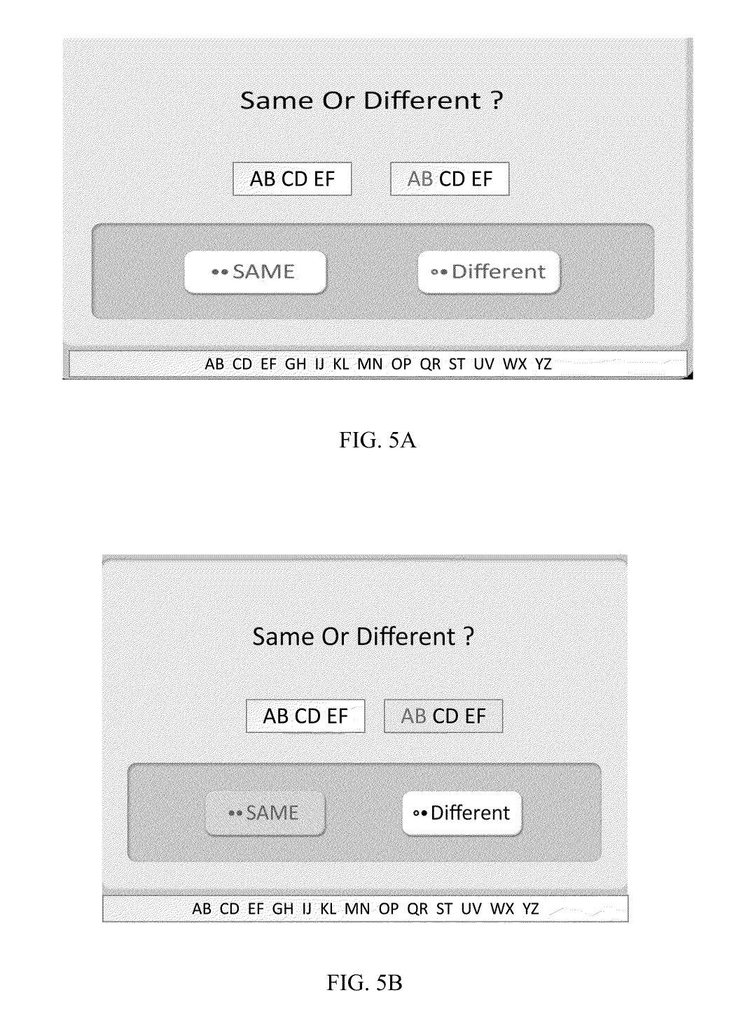

FIGS. 5A-5B depict a number of non-limiting examples of the exercises for reasoning about the sameness and differentness in two incomplete open-bigram sequences. FIG. 5A shows two incomplete open-bigram sequences, each comprising three open-bigram terms and prompts the subject to correctly sensory motor select whether the incomplete serial orders of open-bigram terms are the same or different. In this case, the subject is provided with two patterns of incomplete open-bigram sequences comprising open-bigrams terms AB, CD, and EF in the same serial order but containing different spatial or time perceptual related attributes (the letter symbols AB are of a different time perceptual related attribute font color in each of the two patterns of incomplete open-bigram sequences).

In this exercise, the subject should sensory motor select that the two patterns of incomplete serial orders of open-bigram terms are different, as is shown in FIG. 5B. While the exercise depicted in FIGS. 5A and 5B shows one of the open-bigram terms having a changed time perceptual related attribute in the form of a font color change, it is understood that any previously discussed spatial or time perceptual related attribute could be changed in lieu of, or in addition to, the changed time perceptual related attribute font color. The subject matter of Example 2 contemplates that up to 7 different spatial or time perceptual related attributes could be changed among the two incomplete open-bigram sequences, where the subject is required to reason in order to sensorially discriminate sameness or differentness and subsequently sensory motor select the correct incomplete serial order pattern of open-bigram terms answer. Furthermore, the exercise in FIGS. 5A and 5B uses a portion (incomplete direct alphabetic set array) of a direct alphabetical serial order of open-bigram terms, and it should be understood that a portion (incomplete inverse alphabetic set array) of an inverse alphabetical serial order of open-bigram terms are also used in the various exercises. It should also be understood that, while the exercise in FIGS. 5A and 5B depict two incomplete serial orders comprising three open-bigram terms each, any number of open-bigram terms may be used in the incomplete open-bigram sequences, with preferably 2-7 open-bigram terms per incomplete sequence.

Furthermore, it is noted that the incomplete serial order of open-bigram terms in each of the two open-bigram term sequences are of consecutive open-bigram terms from a direct alphabetic set array of open-bigram terms. It is contemplated that the incomplete serial order of open-bigram terms of the two open-bigram terms sequences provided to the subject could also be non-consecutive open-bigram terms from a direct alphabetic set array of open-bigram terms, as well as consecutive open-bigram terms from an inverse alphabetic set array of open-bigram terms, or non-consecutive open-bigram terms from an inverse alphabetic set array of open-bigram terms.

1. A method of promoting fluid intelligence abilities in a subject, configured according to one or more serial orders of different letter pairs, known as open-bigrams, each letter pair formed from two different letters obtained from a complete alphabetic open-bigram set array of an alphabet, the subject required to sensory motor discriminate the letter pairs and ordinal positions of the letter pairs in predefined complete and/or incomplete serial orders of open-bigrams during an exercise, the method comprising:
a) selecting one or more complete serial orders of alphabetic set arrays of open-bigram terms obtained from a predefined library of alphabetic open-bigrams set arrays, wherein the serial order of letters of two or more consecutive terms in a direct or inverse serial order do not form a word, and wherein the exercise does not require the subject to retrieve semantic knowledge from long term memory;
b) providing the subject with one or more incomplete serial orders of alphabetic open-bigram terms obtained from the selected one or more serial orders, wherein one or more preselected alphabetic open-bigram terms have been subtracted and the incomplete serial orders follow the same serial order as the selected complete serial orders; and providing one complete alphabetic open-bigram set array from the predefined library to the subject in a ruler;
c) prompting the subject, within the exercise, to reason in order to sensorially discriminate and sensory motor select the subtracted alphabetic open-bigram terms to insert within the provided one or more incomplete serial orders of alphabetic open-bigram terms of step b) to obtain the same selected alphabetic open-bigrams set arrays of step a), or to reason in order to sensorially discriminate differences or sameness between two or more of the provided incomplete alphabetic serial orders of open-bigram terms of step b), within a first predefined time interval;
d) determining whether the subject correctly sensory motor selected the alphabetic open-bigram terms in step c) or correctly sensorially discriminated differences or sameness between the two or more incomplete alphabetic serial orders of open-bigram terms in step c);
e) if the subject made an incorrect open-bigram term sensory motor selection or sensorial discrimination of differences or sameness, then automatically returning to step b);
f) for each correctly sensory motor selected alphabetic open-bigram term or correctly sensorially discriminated differences or sameness between the two or more of the incomplete alphabetic serial orders of open-bigram terms according to step d), displaying the correct sensory motor selected open-bigram term or sensorially discriminated differences or sameness with at least one changed spatial and/or time perceptual related attribute;
g) repeating the above steps for a predetermined number of iterations separated by one or more predefined time intervals; and
h) upon completion of the predetermined number of iterations, providing the subject with the results of each iteration.

2. The method of claim 1, wherein the sensory motor selection of open-bigram terms or sensorial discrimination of differences or sameness of the alphabetic open-bigram terms of the provided one or more incomplete serial orders of open-bigram terms obtained from alphabetic open-bigram set arrays does not invoke awareness of semantic knowledge by the subject.

3. The method of claim 1 wherein the selection of serial orders of alphabetic open-bigram terms from the predefined library and the selection of incomplete serial orders of alphabetic open-bigram terms from the selected set arrays are done at random according to a preselected mathematical algorithm.

4. The method of claim 1, wherein the one or more serial orders of alphabetic open-bigram terms in the predefined library of alphabetic open-bigram set arrays comprise a predefined number of different alphabetic open-bigram term members, each open-bigram term member of each set array having a predefined unique ordinal position, wherein none of the different alphabetic open-bigram term members are repeated within the set arrays and each different open-bigram term member is located at a different ordinal position within the set arrays.

5. The method of claim 1, wherein the predefined library includes alphabetic set arrays where each member term is a different alphabetic open-bigram term, the set arrays comprising: direct alphabetic open-bigram set array, inverse alphabetic open-bigram set array, direct type alphabetic open-bigram set array, inverse type alphabetic open-bigram set array, central type alphabetic open-bigram set array, and inverse central type alphabetic open-bigram set array, and
wherein the serial order of the letters of two or more consecutive member terms do not form a word.

6. The method of claim 1, wherein the two or more incomplete serial orders of alphabetic open-bigram terms contain at least one different spatial and/or time perceptual related attribute between each of the two or more incomplete serial orders of alphabetic open-bigram terms.

7. The method of claim 6, wherein the different spatial and/or time perceptual related attribute between the two or more incomplete serial orders of alphabetic open-bigram terms is selected from one or more of symbol font color, symbol font size, symbol font style, symbol font spacing, symbol font case, symbol font boldness, symbol font angle of rotation, and symbol font mirroring.

8. The method of claim 6, wherein the two or more incomplete serial orders of alphabetic open-bigram terms contain a plurality of different spatial and/or time perceptual related attributes between each of the two or more incomplete serial orders of alphabetic open-bigram terms.

9. The method of claim 8, wherein each different spatial and/or time perceptual related attribute between the two or more incomplete serial orders of alphabetic open-bigram terms is selected from one or more of symbol font color, symbol font size, symbol font style, symbol font spacing, symbol font case, symbol font boldness, symbol font angle of rotation, and symbol font mirroring.

10. The method of claim 1, wherein the subject's reasoning in order to sensory motor select subtracted open-bigrams or sensorially discriminate differences or sameness engages goal oriented motor activity within the subject's body, the goal oriented motor activity selected from the sensory motor group including: sensorial perception of the selected one or more serial orders of alphabetic open-bigram terms and the selected one or more incomplete serial orders of open-bigram terms, goal oriented body movements to execute the sensory motor selections or sensorial discriminations, and combinations thereof.

11. The method of claim 10, wherein the goal oriented body movements are selected from the group consisting of goal oriented movements relating to a subject's eyes, head, neck, arms, hands, fingers and combinations thereof.

12. (canceled)

13. The method of claim 1, wherein the predetermined number of iterations ranges from 1 to 23 iterations.

14. The method of claim 1, wherein the sensory motor selection of alphabetic open-bigram terms is done by the subject by implementing a force choice selection method.

15. The method of claim 1, wherein the at least one changed spatial and/or time perceptual related attribute of step f) is selected according to a predefined relationship between the spatial and/or time perceptual related attributes and the ordinal positions of the alphabetic open-bigram terms in the selected open-bigram set array.

16. The method of claim 15, wherein the at least one changed spatial and/or time perceptual related attribute of an alphabetic open-bigram term having an ordinal position falling in a left field of vision of the subject is different from the at least one changed spatial and/or time perceptual related attribute of an alphabetic open-bigram term having an ordinal position falling in a right field of vision of the subject.

17. A computer program product for promoting fluid intelligence abilities in a subject, configured according to one or more serial orders of different letter pairs, known as open-bigrams, each letter pair formed from two different letters obtained from a complete alphabetic open-bigram set array of an alphabet, the subject required to sensory motor discriminate the letter pairs and ordinal positions of the letter pairs in predefined complete and/or incomplete serial orders of open-bigrams during an exercise, the computer program product stored on a non-transitory computer-readable medium, which when executed causes a computer system to perform a method, comprising:
a) selecting one or more complete serial orders of alphabetic set arrays of open-bigram terms obtained from a predefined library of alphabetic open-bigrams set arrays, wherein the serial order of letters of two or more consecutive terms in a direct or inverse serial order do not form a word, and wherein the exercise does not require the subject to retrieve semantic knowledge from long term memory;
b) providing the subject with one or more incomplete serial orders of alphabetic open-bigram terms obtained from the selected one or more serial orders, wherein one or more preselected alphabetic open-bigram terms have been subtracted and the incomplete serial orders follow the same serial order as the selected complete serial orders; and providing one complete alphabetic open-bigram set array from the predefined library to the subject in a ruler;
c) prompting the subject, within the exercise, to reason in order to sensorially discriminate and sensory motor select the subtracted alphabetic open-bigram terms to insert within the provided one or more incomplete serial orders of alphabetic open-bigram terms of step b) to obtain the same selected alphabetic open-bigrams set arrays of step a), or to reason in order to sensorially discriminate differences or sameness between two or more of the provided incomplete alphabetic serial orders of open-bigram terms of step b), within a first predefined time interval;
d) determining whether the subject correctly sensory motor selected the alphabetic open-bigram terms in step c) or correctly sensorially discriminated differences or sameness between the two or more incomplete alphabetic serial orders of open-bigram terms in step c);
e) if the subject made an incorrect open-bigram term sensory motor selection or sensorial discrimination of differences or sameness, then automatically returning to step b);
f) for each correctly sensory motor selected alphabetic open-bigram term or correctly sensorially discriminated differences or sameness between the two or more incomplete alphabetic serial orders of open-bigram terms according to step d), displaying the correct sensory motor selected open-bigram term or sensorially discriminated differences or sameness with at least one changed spatial and/or time perceptual related attribute;
g) repeating the above steps for a predetermined number of iterations separated by one or more predefined time intervals; and
h) upon completion of the predetermined number of iterations, providing the subject with the results of each iteration.

18. A system for promoting fluid intelligence abilities in a subject, configured according to one or more serial orders of different letter pairs, known as open-bigrams, each letter pair formed from two different letters obtained from a complete alphabetic open-bigram set array of an alphabet, the subject required to sensory motor discriminate the letter pairs and ordinal positions of the letter pairs in predefined complete and/or incomplete serial orders of open-bigrams during an exercise, the system comprising:
a computer system comprising a processor, memory, and a graphical user interface (GUI), the processor containing instructions for:
a) selecting one or more complete serial orders of alphabetic set arrays of open-bigram terms obtained from a predefined library of alphabetic open-bigrams set arrays, wherein the serial order of letters of two or more consecutive terms in a direct or inverse serial order do not form a word, and wherein the exercise does not require the subject to retrieve semantic knowledge from long term memory;
b) providing the subject with one or more incomplete serial orders of alphabetic open-bigram terms obtained from the selected one or more serial orders on the GUI, wherein one or more preselected alphabetic open-bigram terms have been subtracted and the incomplete serial orders follow the same serial order as the selected complete serial orders; and providing one complete alphabetic open-bigram set array from the predefined library to the subject in a ruler on the GUI;
c) prompting the subject on the GUI, within the exercise, to reason in order to sensorially discriminate and sensory motor select the subtracted alphabetic open-bigram terms to insert within the provided one or more incomplete serial orders of alphabetic open-bigram terms of step b) to obtain the same selected alphabetic open-bigrams set arrays of step a), or to reason in order to sensorially discriminate differences or sameness between two or more of the provided incomplete alphabetic serial orders of open-bigram terms of step b), within a first predefined time interval;
d) determining whether the subject correctly sensory motor selected the alphabetic open-bigram terms in step c) or correctly sensorially discriminated differences or sameness between the two or more incomplete alphabetic serial orders of open-bigram terms in step c);
e) if the subject made an incorrect open-bigram term sensory motor selection or sensorial discrimination of differences or sameness, then automatically returning to step b);
f) for each correctly sensory motor selected alphabetic open-bigram term or correctly sensorially discriminated differences or sameness between the two or more incomplete alphabetic serial orders of open-bigram terms according to step d), displaying the correct sensory motor selected open-bigram term or sensorially discriminated differences or sameness on the GUI with at least one changed spatial and/or time perceptual related attribute;
g) repeating the above steps for a predetermined number of iterations separated by one or more predefined time intervals; and
h) upon completion of the predetermined number of iterations, providing the subject with the results of each iteration on the GUI.

19. A method of promoting fluid intelligence abilities in a subject, configured according to one or more serial orders of different letter pairs, known as open-bigrams, each letter pair formed from two different letters obtained from a complete alphabetic open-bigram set array of an alphabet, the subject required to sensory motor discriminate the letter pairs and ordinal positions of the letter pairs in predefined complete and/or incomplete serial orders of open-bigrams during an exercise, the method comprising:
a) selecting a complete serial order of an alphabetic set array of open-bigram terms from a predefined library of complete alphabetic open-bigram set arrays, wherein the serial order of letters of two or more consecutive terms in a direct or inverse serial order do not form a word, and wherein the exercise does not require the subject to retrieve semantic knowledge from long term memory;
b) providing the subject with an incomplete serial order of alphabetic open-bigram terms selected from the complete serial order of the alphabetic open-bigram set array, wherein single open-bigram terms have been removed, and all of the remaining open-bigram terms in the incomplete serial order of open-bigram terms have the same spatial and/or time perceptual related attributes; and providing the selected complete serial order of the alphabetic open-bigram set array to the subject in a ruler;
c) prompting the subject, within the exercise, to reason in order to sensory motor select, in a first predefined time interval, the open-bigram term corresponding to a next ordinal position in the incomplete serial order of alphabetic open-bigram terms from a list of possible alphabetic open-bigram term answer choices shown to the subject;
d) for each correct sensory motor selection made by the subject, displaying the correctly sensory motor selected open-bigram term with a different spatial and/or time perceptual related attribute than the incomplete serial order of open-bigram terms in step b);
e) if the sensory motor selection made by the subject is an incorrect selection, then automatically returning to step c);
f) repeating the above steps for a predefined number of iterations separated by one or more predefined time intervals; and
g) upon completion of the predefined number of iterations, providing the subject with the results of each iteration.

20. The method of claim 19, wherein the selection of the complete serial order of the alphabetic open-bigram set array of step a) is done at random, and wherein the incomplete serial order of alphabetic open-bigram terms of step b) is randomly selected from a predefined number of the alphabetic open-bigram terms in the selected complete serial order, according to a mathematical algorithm.

21. The method of claim 19, wherein the predefined library comprises alphabetic set arrays where each member of the set is an open-bigram term, the alphabetic set arrays comprising: direct alphabetic open-bigram set array, inverse alphabetic open-bigram set array, direct type alphabetic open-bigram set array, inverse type alphabetic open-bigram set array, central type alphabetic open-bigram set array, and inverse central type alphabetic open-bigram set array, and
wherein the serial order of the letters of two or more consecutive terms do not form a word.

22. The method of claim 19, wherein the different spatial and/or time perceptual related attribute of step c) is selected from one or more of symbol font color, symbol font size, symbol font style, symbol font spacing, symbol font case, symbol font boldness, symbol font angle of rotation, and symbol font mirroring.

23. The method of claim 19, wherein the different spatial and/or time perceptual related attribute of step d) is selected according to a predefined relationship between the spatial and/or time perceptual related attributes and an ordinal position of the alphabetic open-bigram terms in the selected set array.

24. The method of claim 23, wherein the different spatial and/or time perceptual related attribute of an alphabetic open-bigram term having an ordinal position falling in a left field of vision of the subject is different from the different spatial and/or time perceptual related attribute of an alphabetic open-bigram term having an ordinal position falling in a right field of vision of the subject.

25. The method of claim 19, wherein the incomplete serial order of alphabetic open-bigram terms comprises consecutive open-bigram member terms.

26. The method of claim 19, wherein the incomplete serial order of alphabetic open-bigram terms comprises non-consecutive open-bigram member terms.

27. The method of claim 19, wherein the incomplete serial order of alphabetic open-bigram terms comprises 2-6 open-bigram terms.

28. The method of claim 27, wherein the incomplete serial order of alphabetic open-bigram terms has 3 open-bigram terms.

29. The method of claim 19, wherein the subject's reasoning in order to sensory motor select the alphabetic open-bigram term having the next ordinal position according to step c) engages goal oriented motor activity within the subject's body, the goal oriented motor activity selected from the sensory motor group including: sensorial perception of the incomplete serial order of alphabetic open-bigram terms, goal oriented body movements involved in prompting the subject according to step c), and combinations thereof.

30. The method of claim 29, wherein the goal oriented body movements are selected from the group consisting of goal oriented movements relating to a subject's eyes, head, neck, arms, hands, fingers and combinations thereof.

31. (canceled)

32. The method of claim 19, wherein the predetermined number of iterations ranges from 1-23 iterations.

33. The method of claim 19 wherein the sensory motor selection of alphabetic open-bigram terms is done by the subject by implementing a predefined selection choice method selected from the group including multiple-choice selection method, force choice selection method, and go-no go selection method.

34. The method of claim 19, wherein the first predefined time interval is any time interval between 10 and 20 seconds.

35. A computer program product for promoting fluid intelligence abilities in a subject, configured according to one or more serial orders of different letter pairs, known as open-bigrams, each letter pair formed from two different letters obtained from a complete alphabetic open-bigram set array of an alphabet, the subject required to sensory motor discriminate the letter pairs and ordinal positions of the letter pairs in predefined complete and/or incomplete serial orders of open-bigrams during an exercise, the computer program product stored on a non-transitory computer-readable medium which when executed causes a computer system to perform a method, comprising:
a) selecting a complete serial order of an alphabetic set array of open-bigram terms from a predefined library of complete alphabetic open-bigram set arrays, wherein the serial order of letters of two or more consecutive terms in a direct or inverse serial order do not form a word, and wherein the exercise does not require the subject to retrieve semantic knowledge from long term memory;
b) providing the subject with an incomplete serial order of alphabetic open-bigram terms selected from the complete serial order of the alphabetic open-bigram set array, wherein single open-bigram terms have been removed, and all of the remaining open-bigram terms in the incomplete serial order of open-bigram terms have the same spatial and/or time perceptual related attributes; and providing the selected complete serial order of the alphabetic open-bigram set array to the subject in a ruler;
c) prompting the subject to reason in order to sensory motor select, in a first predefined time interval, the open-bigram term corresponding to a next ordinal position in the incomplete serial order of alphabetic open-bigram terms from a list of possible alphabetic open-bigram terms answer choices shown to the subject;
d) for each correct sensory motor selection made by the subject, displaying the correctly sensory motor selected open-bigram term with a different spatial and/or time perceptual related attribute than the incomplete serial order of open-bigram terms in step b);
e) if the sensory motor selection made by the subject is an incorrect selection, then automatically returning to step c;
f) repeating the above steps for a predefined number of iterations separated by one or more predefined time intervals; and
g) upon completion of the predefined number of iterations, providing the subject with the results of each iteration.

36. A system for promoting fluid intelligence abilities in a subject, configured according to one or more serial orders of different letter pairs, known as open-bigrams, each letter pair formed from two different letters obtained from a complete alphabetic open-bigram set array of an alphabet, the subject required to sensory motor discriminate the letter pairs and ordinal positions of the letter pairs in predefined complete and/or incomplete serial orders of open-bigrams during an exercise, the system comprising:
a computer system comprising a processor, memory, and a graphical user interface (GUI), the processor containing instructions for:
a) selecting a complete serial order of an alphabetic set array of open-bigram terms from a predefined library of complete alphabetic open-bigram set arrays, wherein the serial order of letter of two or more consecutive terms in a direct or inverse serial order do not form a word, and wherein the exercise does not require the subject to retrieve semantic knowledge from long term memory;
b) providing the subject with an incomplete serial order of alphabetic open-bigram terms selected from the complete serial order of the alphabetic open-bigram set array on the GUI, wherein single open-bigram terms have been removed, and all of the remaining open-bigram terms in the incomplete serial order of open-bigram terms have the same spatial and/or time perceptual related attributes; and providing the selected complete serial order of the alphabetic open-bigram set array to the subject in a ruler on the GUI;
c) prompting the subject on the GUI to reason in order to sensory motor select, in a first predefined time interval, the open-bigram term corresponding to a next ordinal position in the incomplete serial order of alphabetic open-bigram terms from a list of possible alphabetic open-bigram term answer choices shown to the subject;
d) for each correct sensory motor selection made by the subject, displaying the correctly sensory motor selected open-bigram term on the GUI with a different spatial and/or time perceptual related attribute than the incomplete serial order of open-bigram terms in step b);
e) if the sensory motor selection made by the subject is an incorrect selection, then automatically returning to step c);
f) repeating the above steps for a predefined number of iterations separated by one or more predefined time intervals; and
g) upon completion of the predefined number of iterations, providing the subject with the results of each iteration on the GUI.

37. A method of promoting fluid intelligence abilities in a subject, configured according to one or more serial orders of different letter pairs, known as open-bigrams, each letter pair formed from two different letters obtained from a complete alphabetic open-bigram set array of an alphabet, the subject required to sensory motor discriminate the letter pairs and ordinal positions of the letter pairs in predefined complete and/or incomplete serial orders of open-bigrams during an exercise, the method comprising:
a) selecting a pair of complete serial orders of alphabetic set arrays of open-bigram terms from a predefined library of open-bigram set arrays, wherein the serial order of letters of two or more consecutive terms in a direct or inverse serial order do not form a word, and wherein the exercise does not require the subject to retrieve semantic knowledge from long term memory;
b) providing the subject with two incomplete serial orders of alphabetic open-bigram term sequences selected from each of the pair of complete serial orders of alphabetic open-bigram set arrays, wherein a predefined number of open-bigram terms at selected ordinal positions in the set arrays are the same in the two incomplete serial orders of alphabetic open-bigram term sequences; and providing a complete serial order of an alphabetic open-bigram set array to the subject in a ruler;
c) prompting the subject to reason in order to sensorially discriminate and sensory motor select, within a first predefined time interval, whether the two incomplete serial orders of alphabetic open-bigram term sequences are either the same or different for at least one spatial and/or time perceptual related attribute;
d) if the sensory motor selection made by the subject is incorrect, then automatically returning to step c);
e) for each correct sensory motor selection made by the subject where the two incomplete serial orders of open-bigram term sequences are the same, then changing at least one spatial and/or time perceptual related attribute in both incomplete serial orders of alphabetic open-bigram term sequences;
f) for each correct sensory motor selection made by the subject where the two incomplete serial orders of alphabetic open-bigram term sequences are different, then changing at least one spatial and/or time perceptual related attribute of only one of the incomplete serial orders of alphabetic open-bigram term sequences;
g) repeating the above steps for a predetermined number of iterations separated by one or more predefined time intervals; and
h) upon completion of the predetermined number of iterations, providing the subject with the results of each iteration.

38. The method of claim 37, wherein the selection of both the pair of complete serial orders of alphabetic open-bigram set arrays in step a) and the two incomplete serial orders of alphabetic open-bigram term sequences in step b) are is done at random according to a mathematical algorithm.

39. The method of claim 37, wherein the predefined library comprises alphabetic set arrays where each member of the set is a different open-bigram term, the alphabetic set arrays comprising: direct open-bigram set array, inverse open-bigram set array, direct type open-bigram set array, inverse type open-bigram set array, central type open-bigram set array, and inverse central type open-bigram set array, and
wherein the serial order of the letters in two or more consecutive open-bigrams do not form a word.

40. The method of claim 37, wherein the two incomplete serial orders of open-bigram term sequences comprise consecutive open-bigram member terms.

41. The method of claim 37, wherein the two incomplete serial orders of open-bigram term sequences comprise non-consecutive open-bigram member terms.

42. The method of claim 37, wherein the two incomplete serial orders of open-bigram term sequences are different, and the difference comprises at least one different spatial and/or time perceptual related attribute selected from one or more of symbol font color, symbol font size, symbol font style, symbol font spacing, symbol font case, symbol font boldness, symbol font angle of rotation, and symbol font mirroring.

43. The method of claim 37, wherein each incomplete serial orders of open-bigram term sequence comprises 2-7 open-bigram terms.

44. The method of claim 37, wherein the changed spatial and/or time perceptual related attribute of the correct sensory motor selection in steps e) and f) is selected from one or more of symbol font color, symbol font size, symbol font style, symbol font spacing, symbol font case, symbol font boldness, symbol font angle of rotation, and symbol font mirroring.

45. The method of claim 37, wherein the changed spatial and/or time perceptual related attribute of steps e) and f) is selected according to a predefined relationship between the spatial and/or time perceptual related attributes and the ordinal positions of the open-bigram terms in the selected alphabetic set array.

46. The method of claim 45, wherein the changed spatial and/or time perceptual related attribute of a correct sensory motor selection having an ordinal position falling in a left field of vision of the subject is different from the changed spatial and/or time perceptual related attribute of a correct sensory motor selection having an ordinal position falling in a right field of vision of the subject.

47. The method of claim 37, wherein the subject's reasoning in order sensorially discriminate and sensory motor select in step c) engages goal oriented motor activity within the subject's body, the goal oriented motor activity selected from the sensory motor group including: sensorial perception of the selected pair of complete serial orders and the two incomplete serial orders of open-bigram term sequences, goal oriented body movements involved in prompting the subject according to step c), and combinations thereof.

48. The method of claim 47, wherein the goal oriented body movements are selected from the group consisting of goal oriented movements relating to a subject's eyes, head, neck, arms, hands, fingers and combinations thereof.

49. The method of claim 37, wherein the complete alphabetic open-bigram set array shown in the ruler is selected from the group including: direct open-bigram set array, inverse open-bigram set array, direct type open-bigram set array, inverse type open-bigram set array, central type open-bigram set array, and inverse central type open-bigram set array.

50. The method of claim 37, wherein the predetermined number of iterations ranges from 1-23 iterations.

51. The method of claim 37, wherein the sensory motor selection is done by the subject by implementing a force choice selection method.

52. The method of claim 37, wherein the first predefined time interval is any time interval between 10 and 20 seconds.

53. A computer program product for promoting fluid intelligence abilities in a subject, configured according to one or more serial orders of different letter pairs, known as open-bigrams, each letter pair formed from two different letters obtained from a complete alphabetic open-bigram set array of an alphabet, the subject required to sensory motor discriminate the letter pairs and ordinal positions of the letter pairs in predefined complete and/or incomplete serial orders of open-bigrams during an exercise, the computer program product stored on a non-transitory computer-readable medium which when executed causes a computer system to perform a method, comprising:
a) selecting a pair of complete serial orders of alphabetic set arrays of open-bigram terms from a predefined library of open-bigram set arrays, wherein the serial order of letters of two or more consecutive terms in a direct or inverse serial order do not form a word, and wherein the exercise does not require the subject to retrieve semantic knowledge from long term memory;
providing the subject with two incomplete serial orders of alphabetic open-bigram term sequences selected from each of the pair of complete serial orders of alphabetic open-bigram set arrays, wherein a predefined number of open-bigram terms at selected ordinal positions in the set arrays are the same in the two incomplete serial orders of alphabetic open-bigram term sequences; and providing a complete serial order of an alphabetic open-bigram set array to the subject in a ruler;
c) prompting the subject to reason in order to sensorially discriminate and sensory motor select, within a first predefined time interval, whether the two incomplete serial orders of alphabetic open-bigram term sequences are either the same or different for at least one spatial and/or time perceptual related attribute;
d) if the sensory motor selection made by the subject is incorrect, then automatically returning to step c);
e) for each correct sensory motor selection made by the subject where the two incomplete serial orders of open-bigram term sequences are the same, then changing at least one spatial and/or time perceptual related attribute in both incomplete serial orders of alphabetic open-bigram term sequences;
f) for each correct sensory motor selection made by the subject where the two incomplete serial orders of open-bigram term sequences are different, then changing at least one spatial and/or time perceptual related attribute of only one of the incomplete serial orders of alphabetic open-bigram term sequences;
g) repeating the above steps for a predetermined number of iterations separated by one or more predefined time intervals; and
h) upon completion of the predetermined number of iterations, providing the subject with the results of each iteration.

54. A system for promoting fluid intelligence abilities in a subject, configured according to one or more serial orders of different letter pairs, known as open-bigrams, each letter pair formed from two different letters obtained from a complete alphabetic open-bigram set array of an alphabet, the subject required to sensory motor discriminate the letter pairs and ordinal positions of the letter pairs in predefined complete and/or incomplete serial orders of open-bigrams during an exercise, the system comprising:
a computer system comprising a processor, memory, and a graphical user interface (GUI), the processor containing instructions for:
a) selecting a pair of complete serial orders of alphabetic set arrays of open-bigram terms from a predefined library of alphabetic open-bigram set arrays, wherein the serial order of letters of two or more consecutive terms in a direct or inverse serial order do not form a word, and wherein the exercise does not require the subject to retrieve semantic knowledge from long term memory;
b) providing the subject with two incomplete serial orders of alphabetic open-bigram term sequences selected from each of the pair of complete serial orders of alphabetic open-bigram set arrays on the GUI, wherein a predefined number of open-bigram terms at selected ordinal positions in the set arrays are the same in the two incomplete serial orders of alphabetic open-bigram term sequences; and providing a complete serial order of an alphabetic open-bigram set array to the subject in a ruler on the GUI;
c) prompting the subject on the GUI to reason in order to sensorially discriminate and sensory motor select, within a first predefined time interval, whether the two incomplete serial order of alphabetic open-bigram term sequences are either the same or different for at least one spatial and/or time perceptual related attribute;
d) if the sensory motor selection made by the subject is incorrect, then automatically returning to step c);
e) for each correct sensory motor selection made by the subject where the two incomplete serial orders of open-bigram term sequences are the same, then changing at least one spatial and/or time perceptual related attribute in both incomplete serial orders of alphabetic open-bigram term sequences on the GUI;
f) for each correct sensory motor selection made by the subject where the two incomplete serial orders of open-bigram term sequences are different, then changing at least one spatial and/or time perceptual related attribute of only one of the incomplete serial orders of alphabetic open-bigram term sequences on the GUI;
g) repeating the above steps for a predetermined number of iterations separated by one or more predefined time intervals; and
h) upon completion of the predetermined number of iterations, providing the subject with the results of each iteration on the GUI.

55. The method of claim 1, wherein at least ten consecutive changes of the spatial and/or time perceptual related attributes of step f) are all different.

56. The method of claim 19, wherein at least ten consecutive changes of the spatial and/or time perceptual related attributes of step c) are all different.
